(19) United States
(12) Patent Application Publication
(10) Pub. No.: US 2017/0347154 A1
(43) Pub. Date: Nov. 30, 2017

(54) VIDEO DISPLAY APPARATUS AND OPERATING METHOD THEREOF

(71) Applicant: LG ELECTRONICS INC., Seoul (KR)

(72) Inventors: Huisang YOO, Seoul (KR); Kyoungsoo MOON, Seoul (KR); Seungjoo AN, Seoul (KR); Younghun SONG, Seoul (KR); Jinwon LEE, Seoul (KR)

(73) Assignee: LG ELECTRONICS INC., Seoul (KR)

(21) Appl. No.: 15/528,311

(22) PCT Filed: Dec. 17, 2014
(86) PCT No.: PCT/KR2014/012505

§ 371 Date: May 19, 2017

(30) Foreign Application Priority Data
Nov. 21, 2014 (KR) 10-2014-0163364

(51) Int. Cl. H04N 21/45; G06Q 30/02; H04N 21/466; H04N 21/472

(52) U.S. Cl. CPC H04N 21/4532; H04N 21/472; G06Q 30/0269; H04N 21/4668

(57) ABSTRACT

The operating method of a video display apparatus according to an embodiment of the present invention comprises the steps of: recognizing content by using automatic content recognition; displaying a questionnaire for personalized service when the number of use of the recognized content reaches a threshold; receiving a user response to the displayed questionnaire; and providing the personalized service on the basis of the questionnaire reflecting the received user response.

### TECHNICAL FIELD

The present invention relates to a video display apparatus and an operating method thereof.

### BACKGROUND ART

As digital broadcast services have been provided and digital technologies have been developed, technology for providing a high-quality broadcast service is attracting considerable attention.

In addition to an existing broadcast service, user demands for customized content and broadcast services have increased.

However, a system for collecting user information of a current broadcast system and processing the collected user information was not established. Accordingly, it is difficult to provide a broadcast service suitable for a user.

### DISCLOSURE

### Technical Problem

An object of the present invention is to provide a video display apparatus capable of checking user characteristics through a questionnaire and providing a customized service to a user, and an operating method thereof.

Another object of the present invention is to provide a video display apparatus capable of checking user characteristics through a questionnaire and providing customized advertisement content to each user to obtain positive advertisement effects, and an operating method thereof.

### Technical Solution

A method of operating a video display apparatus according to an embodiment of the present invention includes recognizing content using an automatic content recognition scheme, displaying a questionnaire for a personalized service if the number of times of using the recognized content is equal to or greater than a threshold, receiving an answer of a user to the displayed questionnaire and providing the personalized service based on the questionnaire, to which the received answer of the user is applied.

A video display apparatus according to an embodiment of the present invention includes a display unit and a controller configured to recognize content using an automatic content recognition scheme, to control the display unit to display a questionnaire for a personalized service if the number of times of using the recognized content is equal to or greater than a threshold, to receive an answer of a user to the displayed questionnaire, and to provide the personalized service based on the questionnaire, to which the received answer of the user is applied.

### Advantageous Effects

According to embodiments of the present invention, it is possible to check user characteristics through a questionnaire and to provide a customized service to a user.

In addition, it is possible to check user characteristics through a questionnaire and to provide customized advertisement content to each user. Therefore, it is possible to obtain positive advertisement effects.

According to embodiments of the present invention, it is possible to provide a menu for providing a service related to content through a second screen instead of a screen of a video display apparatus. Therefore, it is possible to minimize user convenience upon viewing a video.

### DESCRIPTION OF DRAWINGS

FIG. 1 is a block diagram of a network topology according to an embodiment.

FIG. 2 is a block diagram of a watermark based network topology according to an embodiment.

FIG. 3 is a ladder diagram of a data flow in a watermark based network topology according to an embodiment.

FIG. 4 shows a watermark based content recognition timing according to an embodiment.

FIG. 5 is a block diagram of a fingerprint based network topology according to an embodiment.

FIG. 6 is a ladder diagram of a data flow in a fingerprint based network topology according to an embodiment.

FIG. 7 is an XML schema diagram of ACR-Resulttype containing a query result according to an embodiment.

FIG. 8 is a block diagram of a watermark and fingerprint based network topology according to an embodiment.

FIG. 9 is a ladder diagram of a data flow in a watermark and fingerprint based network topology according to an embodiment.

FIG. 10 is a block diagram of the video display device according to an embodiment.

FIG. 11 is a diagram showing a digital broadcast system according to an embodiment of the present invention.

FIG. 12 is a ladder diagram illustrating a method of operating a digital broadcast system including a content provision server and a video display apparatus according to an embodiment of the present invention.

FIG. 13 is a diagram showing an example of identifying a user through a plurality of icons and providing a home screen corresponding to the identified user according to an embodiment of the present invention.

FIG. 14 is a diagram showing an XML schema table of a PDI questionnaire according to an embodiment of the present invention.

FIGS. 15 to 17 are diagrams illustrating an example in which a video display apparatus displays a PDI questionnaire received from a content provision server according to an embodiment of the present invention.

FIG. 18 is a diagram illustrating a process of receiving an answer of a user in response to a PDI questionnaire according to an embodiment of the present invention.

FIGS. 19 to 20 are diagrams illustrating examples of providing a personalized service according to various embodiments of the present invention.

FIG. 21 is a ladder diagram illustrating a method of operating a digital broadcast system according to another embodiment of the present invention.

FIG. 22 is a ladder diagram illustrating a method of operating a digital broadcast system according to another embodiment of the present invention.

FIGS. 23 to 25 are diagrams illustrating examples in which a companion device displays a PDI questionnaire received from a content provision server according to an embodiment of the present invention.

FIG. 26 is a ladder diagram illustrating a method of operating a digital broadcast system according to another embodiment of the present invention.

FIGS. 27 to 29 are diagrams illustrating examples in which a video display apparatus provides different advertisement content to each user according to an embodiment of the present invention.

FIG. 30 is a diagram showing an example of providing different advertisement content to a companion device of each user according to another embodiment of the present invention.

FIG. 31 is a block diagram showing the structure of a fingerprint based video display apparatus according to another embodiment of the present invention.

FIG. 32 is a block diagram showing the structure of a watermark based video display apparatus according to another embodiment of the present invention.

### BEST MODE

Hereinafter, a mobile terminal relating to the present invention will be described in more detail with reference to the accompanying drawings. Noun suffixes such as “engine”, “module”, and “unit” for components in description below are given or mixed in consideration of easiness in writing the specification. That is, the noun suffixes themselves does not have respectively distinguishable meanings or roles.

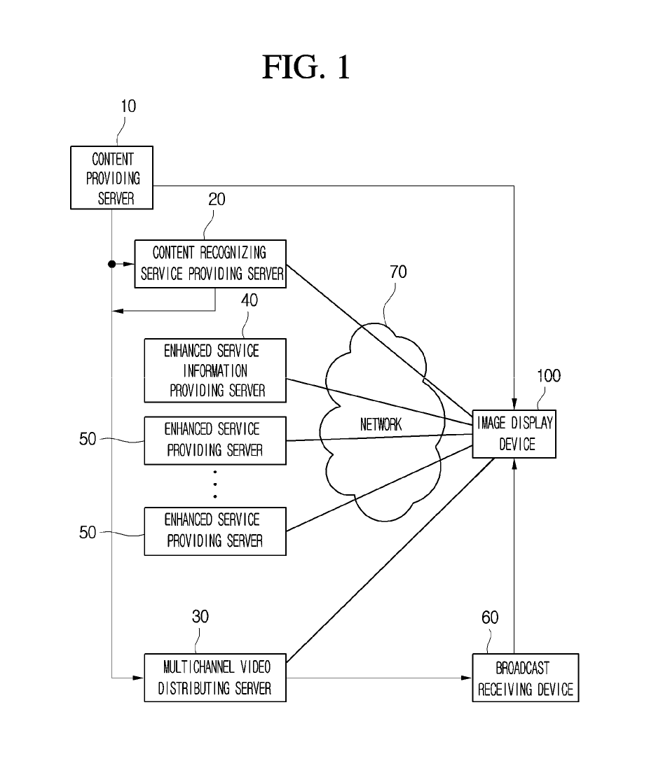

A network topology will be described with reference to FIGS. 1 to 9 according to an embodiment.

FIG. 1 is a block diagram illustrating the network topology according to the embodiment.

As shown in FIG. 1, the network topology includes a content providing server 10, a content recognizing service providing server 20, a multi channel video distributing server 30, an enhanced service information providing server 40, a plurality of enhanced service providing servers 50, a broadcast receiving device 60, a network 70, and a video display device 100.

The content providing server 10 may correspond to a broadcasting station and broadcasts a broadcast signal including main audio-visual contents. The broadcast signal may further include enhanced services. The enhanced services may or may not relate to main audio-visual contents. The enhanced services may have formats such as service information, metadata, additional data, compiled execution files, web applications, Hypertext Markup Language (HTML) documents, XML documents, Cascading Style Sheet (CSS) documents, audio files, video files, ATSC 2.0 contents, and addresses such as Uniform Resource Locator (URL). There may be at least one content providing server.

The content recognizing service providing server 20 provides a content recognizing service that allows the video display device 100 to recognize content on the basis of main audio-visual content. The content recognizing service providing server 20 may or may not edit the main audio-visual content. There may be at least one content recognizing service providing server.

The content recognizing service providing server 20 may be a watermark server that edits the main audio-visual content to insert a visible watermark, which may look a logo, into the main audio-visual content. This watermark server may insert the logo of a content provider at the upper-left or upper-right of each frame in the main audio-visual content as a watermark.

Additionally, the content recognizing service providing server 20 may be a watermark server that edits the main audio-visual content to insert content information into the main audio-visual content as an invisible watermark.

Additionally, the content recognizing service providing server 20 may be a fingerprint server that extracts feature information from some frames or audio samples of the main audio-visual content and stores it. This feature information is called signature.

The multi channel video distributing server 30 receives and multiplexes broadcast signals from a plurality of broadcasting stations and provides the multiplexed broadcast signals to the broadcast receiving device 60. Especially, the multi channel video distributing server 30 performs demodulation and channel decoding on the received broadcast signals to extract main audio-visual content and enhanced service, and then, performs channel encoding on the extracted main audio-visual content and enhanced service to generate a multiplexed signal for distribution. At this point, since the multi channel video distributing server 30 may exclude the extracted enhanced service or may add another enhanced service, a broadcasting station may not provide services led by it. There may be at least one multi channel video distributing server.

The broadcasting device 60 may tune a channel selected by a user and receives a signal of the tuned channel, and then, performs demodulation and channel decoding on the received signal to extract a main audio-visual content. The broadcasting device 60 decodes the extracted main audio-visual content through H.264/Moving Picture Experts Group-4 advanced video coding (MPEG-4 AVC), Dolby AC-3 or Moving Picture Experts Group-2 Advanced Audio Coding (MPEG-2 AAC) algorithm to generate an uncompressed main audio-visual (AV) content. The broadcast receiving device 60 provides the generated uncompressed main AV content to the video display device 100 through its external input port.

The enhanced service information providing server 40 provides enhanced service information on at least one available enhanced service relating to a main AV content in response to a request of a video display device. There may be at least one enhanced service providing server. The enhanced service information providing server 40 may provide enhanced service information on the enhanced service having the highest priority among a plurality of available enhanced services.

The enhanced service providing server 50 provides at least one available enhanced service relating to a main AV content in response to a request of a video display device. There may be at least one enhanced service providing server.

The video display device 100 may be a television, a notebook computer, a hand phone, and a smart phone, each including a display unit. The video display device 100 may receive an uncompressed main AV content from the broadcast receiving device 60 or a broadcast signal including an encoded main AV content from the contents providing server 10 or the multi channel video distributing server 30. The video display device 100 may receive a content recognizing service from the content recognizing service providing server 20 through the network 70, an address of at least one available enhanced service relating to a main AV content from the enhanced service information providing server 40 through the network 70, and at least one available enhanced service relating to a main AV content from the enhanced service providing server 50.

At least two of the content providing server 10, the content recognizing service providing server 20, the multi channel video distributing server 30, the enhanced service information providing server 40, and the plurality of enhanced service providing servers 50 may be combined in a form of one server and may be operated by one provider.

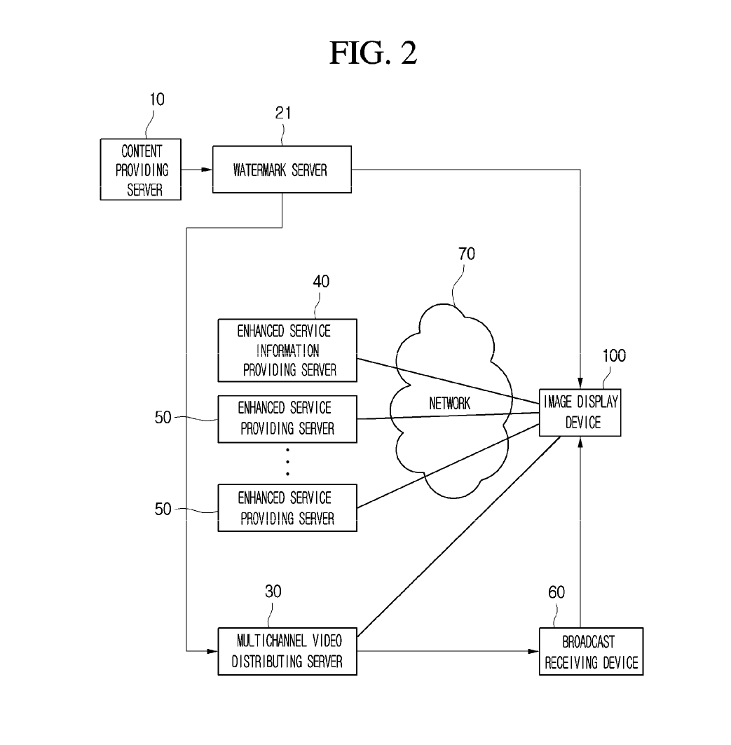

FIG. 2 is a block diagram illustrating a watermark based network topology according to an embodiment.

As shown in FIG. 2, the watermark based network topology may further include a watermark server 21.

As shown in FIG. 2, the watermark server 21 edits a main AV content to insert content information into it. The multi channel video distributing server 30 may receive and distribute a broadcast signal including the modified main AV content. Especially, a watermark server may use a digital watermarking technique described below.

A digital watermark is a process for inserting information, which may be almost undeletable, into a digital signal. For example, the digital signal may be audio, picture, or video. If the digital signal is copied, the inserted information is included in the copy. One digital signal may carry several different watermarks simultaneously.

In visible watermarking, the inserted information may be identifiable in a picture or video. Typically, the inserted information may be a text or logo identifying a media owner. If a television broadcasting station adds its logo in a corner of a video, this is an identifiable watermark.

In invisible watermarking, although information as digital data is added to audio, picture, or video, a user may be aware of a predetermined amount of information but may not recognize it. A secret message may be delivered through the invisible watermarking.

One application of the watermarking is a copyright protection system for preventing the illegal copy of digital media. For example, a copy device obtains a watermark from digital media before copying the digital media and determines whether to copy or not on the bases of the content of the watermark.

Another application of the watermarking is source tracking of digital media. A watermark is embedded in the digital media at each point of a distribution path. If such digital media is found later, a watermark may be extracted from the digital media and a distribution source may be recognized from the content of the watermark.

Another application of invisible watermarking is a description for digital media.

A file format for digital media may include additional information called metadata and a digital watermark is distinguished from metadata in that it is delivered as an AV signal itself of digital media.

The watermarking method may include spread spectrum, quantization, and amplitude modulation.

If a marked signal is obtained through additional editing, the watermarking method corresponds to the spread spectrum. Although it is known that the spread spectrum watermark is quite strong, not much information is contained because the watermark interferes with an embedded host signal.

If a marked signal is obtained through the quantization, the watermarking method corresponds to a quantization type. The quantization watermark is weak, much information may be contained.

If a marked signal is obtained through an additional editing method similar to the spread spectrum in a spatial domain, a watermarking method corresponds to the amplitude modulation.

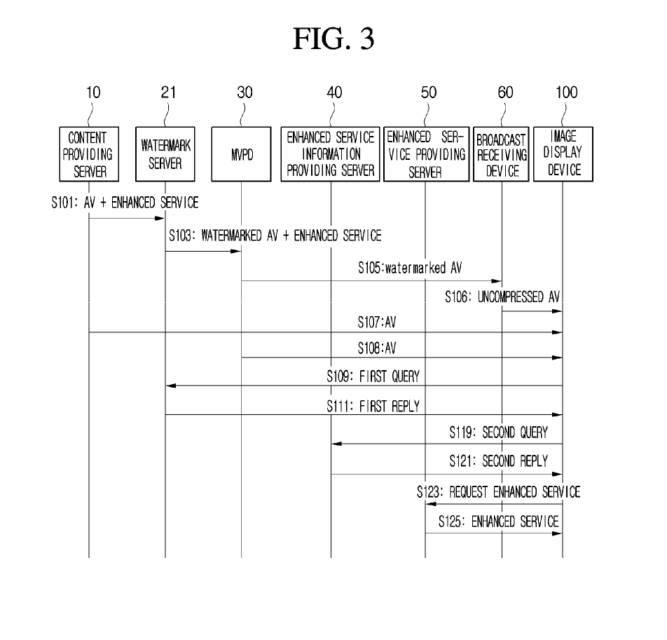

FIG. 3 is a ladder diagram illustrating a data flow in a watermark based network topology according to an embodiment.

First, the content providing server 10 transmits a broadcast signal including a main AV content and an enhanced service in operation S101.

The watermark server 21 receives a broadcast signal that the content providing server 10 provides, inserts a visible watermark such as a logo or watermark information as an invisible watermark into the main AV content by editing the main AV content, and provides the watermarked main AV content and enhanced service to the MVPD 30 in operation S103.

The watermark information inserted through an invisible watermark may include at least one of a watermark purpose, content information, enhanced service information, and an available enhanced service. The watermark purpose represents one of illegal copy prevention, viewer ratings, and enhanced service acquisition.

The content information may include at least one of identification information of a content provider that provides main AV content, main AV content identification information, time information of a content section used in content information acquisition, names of channels through which main AV content is broadcasted, logos of channels through which main AV content is broadcasted, descriptions of channels through which main AV content is broadcasted, a usage information reporting period, the minimum usage time for usage information acquisition, and available enhanced service information relating to main AV content.

If the video display device 100 uses a watermark to acquire content information, the time information of a content section used for content information acquisition may be the time information of a content section into which a watermark used is embedded. If the video display device 100 uses a fingerprint to acquire content information, the time information of a content section used for content information acquisition may be the time information of a content section where feature information is extracted. The time information of a content section used for content information acquisition may include at least one of the start time of a content section used for content information acquisition, the duration of a content section used for content information acquisition, and the end time of a content section used for content information acquisition.

The usage information reporting address may include at least one of a main AV content watching information reporting address and an enhanced service usage information reporting address. The usage information reporting period may include at least one of a main AV content watching information reporting period and an enhanced service usage information reporting period. A minimum usage time for usage information acquisition may include at least one of a minimum watching time for a main AV content watching information acquisition and a minimum usage time for enhanced service usage information extraction.

On the basis that a main AV content is watched for more than the minimum watching time, the video display device 100 acquires watching information of the main AV content and reports the acquired watching information to the main AV content watching information reporting address in the main AV content watching information reporting period.

On the basis that an enhanced service is used for more than the minimum usage time, the video display device 100 acquires enhanced service usage information and reports the acquired usage information to the enhanced service usage information reporting address in the enhanced service usage information reporting period.

The enhanced service information may include at least one of information on whether an enhanced service exists, an enhanced service address providing server address, an acquisition path of each available enhanced service, an address for each available enhanced service, a start time of each available enhanced service, an end time of each available enhanced service, a lifetime of each available enhanced service, an acquisition mode of each available enhanced service, a request period of each available enhanced service, priority information each available enhanced service, description of each available enhanced service, a category of each available enhanced service, a usage information reporting address, a usage information reporting period, and the minimum usage time for usage information acquisition.

The acquisition path of available enhanced service may be represented with IP or Advanced Television Systems Committee-Mobile/Handheld (ATSC M/H). If the acquisition path of available enhanced service is ATSC M/H, enhanced service information may further include frequency information and channel information. An acquisition mode of each available enhanced service may represent Push or Pull.

Moreover, the watermark server 21 may insert watermark information as an invisible watermark into the logo of a main AV content.

For example, the watermark server 21 may insert a barcode at a predetermined position of a logo. At this point, the predetermined position of the logo may correspond to the first line at the bottom of an area where the logo is displayed. The video display device 100 may not display a barcode when receiving a main AV content including a logo with the barcode inserted.

For example, the watermark server 21 may insert watermark information as a metadata form of a logo. At this point, the log may maintain its form.

For example, the watermark server 21 may insert N-bit watermark information at each of the logos of M frames. That is, the watermark server 21 may insert M*N watermark information in M frames.

The MVPD 30 receives broadcast signals including watermarked main AV content and enhanced service and generates a multiplexed signal to provide it to the broadcast receiving device 60 in operation S105. At this point, the multiplexed signal may exclude the received enhanced service or may include new enhanced service.

The broadcast receiving device 60 tunes a channel that a user selects and receives signals of the tuned channel, demodulates the received signals, performs channel decoding and AV decoding on the demodulated signals to generate an uncompressed main AV content, and then, provides the generated uncompressed main AV content to the video display device 100 in operation S106.

Moreover, the content providing server 10 also broadcasts a broadcast signal including a main AV content through a wireless channel in operation S107.

Additionally, the MVPD 30 may directly transmit a broadcast signal including a main AV content to the video display device 100 without going through the broadcast receiving device 60 in operation S108.

The video display device 100 may receive an uncompressed main AV content through the broadcast receiving device 60. Additionally, the video display device 100 may receive a broadcast signal through a wireless channel, and then, may demodulate and decode the received broadcast signal to obtain a main AV content. Additionally, the video display device 100 may receive a broadcast signal from the MVPD 30, and then, may demodulate and decode the received broadcast signal to obtain a main AV content. The video display device 100 extracts watermark information from some frames or a section of audio samples of the obtained main AV content. If watermark information corresponds to a logo, the video display device 100 confirms a watermark server address corresponding to a logo extracted from a corresponding relationship between a plurality of logos and a plurality of watermark server addresses. When the watermark information corresponds to the logo, the video display device 100 cannot identify the main AV content only with the logo. Additionally, when the watermark information does not include content information, the video display device 100 cannot identify the main AV content but the watermark information may include content provider identifying information or a watermark server address. When the watermark information includes the content provider identifying information, the video display device 100 may confirm a watermark server address corresponding to the content provider identifying information extracted from a corresponding relationship between a plurality of content provider identifying information and a plurality of watermark server addresses. In this manner, when the video display device 100 cannot identify a main AV content the video display device 100 only with the watermark information, it accesses the watermark server 21 corresponding to the obtained watermark server address to transmit a first query in operation S109.

The watermark server 21 provides a first reply to the first query in operation S111. The first reply may include at least one of content information, enhanced service information, and an available enhanced service.

If the watermark information and the first reply do not include an enhanced service address, the video display device 100 cannot obtain enhanced service. However, the watermark information and the first reply may include an enhanced service address providing server address. In this manner, the video display device 100 does not obtain a service address or enhanced service through the watermark information and the first reply. If the video display device 100 obtains an enhanced service address providing server address, it accesses the enhanced service information providing server 40 corresponding to the obtained enhanced service address providing server address to transmit a second query including content information in operation S119.

The enhanced service information providing server 40 searches at least one available enhanced service relating to the content information of the second query. Later, the enhanced service information providing server 40 provides to the video display device 100 enhanced service information for at least one available enhanced service as a second reply to the second query in operation S121.

If the video display device 100 obtains at least one available enhanced service address through the watermark information, the first reply, or the second reply, it accesses the at least one available enhanced service address to request enhanced service in operation S123, and then, obtains the enhanced service in operation S125.

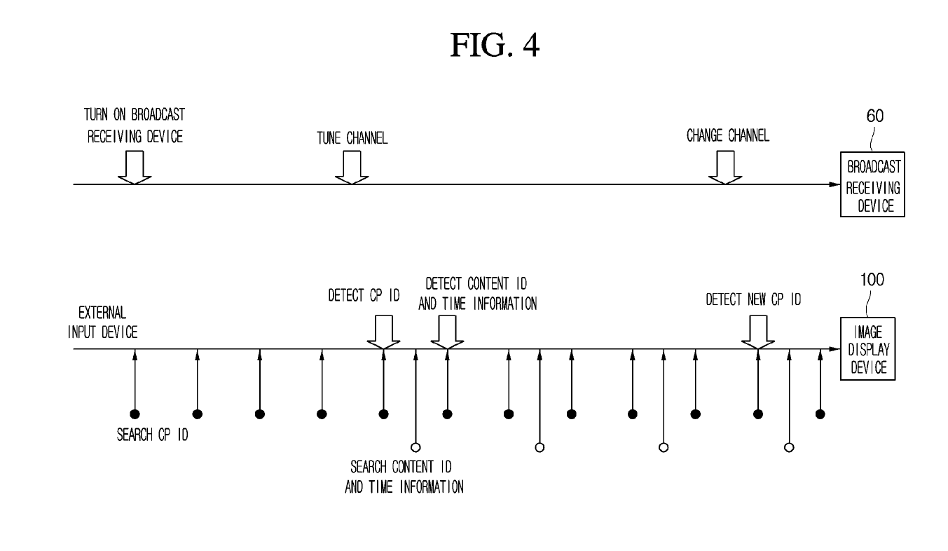

FIG. 4 is a view illustrating a watermark based content recognition timing according to an embodiment.

As shown in FIG. 4, when the broadcast receiving device 60 is turned on and tunes a channel, and also, the video display device 100 receives a main AV content of the turned channel from the broadcast receiving device 60 through an external input port 111, the video display device 100 may sense a content provider identifier (or a broadcasting station identifier) from the watermark of the main AV content. Then, the video display device 100 may sense content information from the watermark of the main AV content on the basis of the sensed content provider identifier.

At this point, as shown in FIG. 4, the detection available period of the content provider identifier may be different from that of the content information. Especially, the detection available period of the content provider identifier may be shorter than that of the content information. Through this, the video display device 100 may have an efficient configuration for detecting only necessary information.

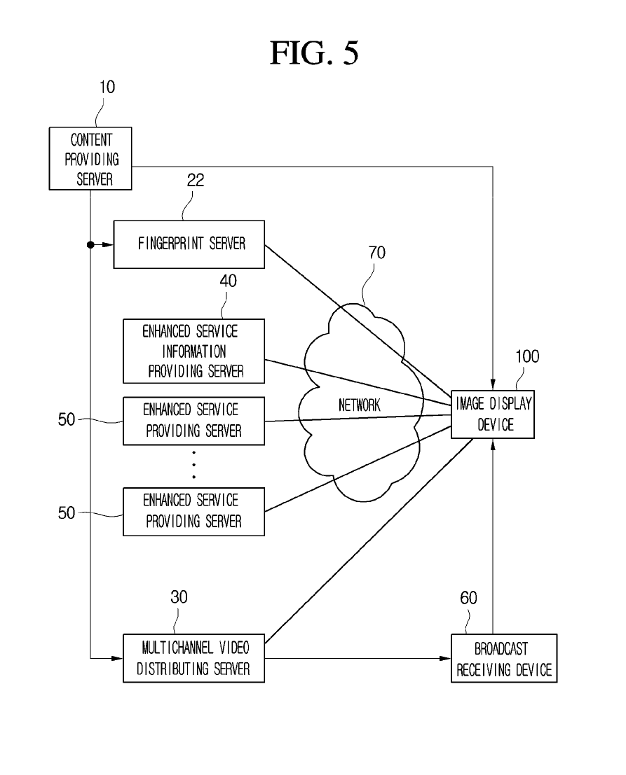

FIG. 5 is a block diagram illustrating a fingerprint based network topology according to an embodiment.

As shown in FIG. 5, the network topology may further include a fingerprint server 22.

As shown in FIG. 5, the fingerprint server 22 does not edit a main AV content, but extracts feature information from some frames or a section of audio samples of the main AV content and stores the extracted feature information. Then, when receiving the feature information from the video display device 100, the fingerprint server 22 provides an identifier and time information of an AV content corresponding to the received feature information.

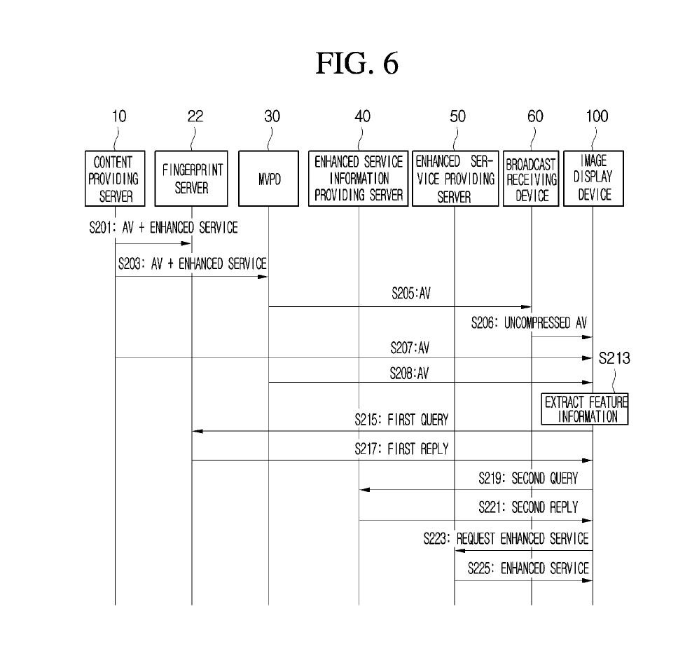

FIG. 6 is a ladder diagram illustrating a data flow in a fingerprint based network topology according to an embodiment.

First, the content providing server 10 transmits a broadcast signal including a main AV content and an enhanced service in operation S201.

The fingerprint server 22 receives a broadcast signal that the content providing server 10, extracts a plurality of pieces of feature information from a plurality of frame sections or a plurality of audio sections of the main AV content, and establishes a database for a plurality of query results corresponding to the plurality of feature information in operation S203. The query result may include at least one of content information, enhanced service information, and an available enhanced service.

The MVPD 30 receives broadcast signals including a main AV content and enhanced service and generates a multiplexed signal to provide it to the broadcast receiving device 60 in operation S205. At this point, the multiplexed signal may exclude the received enhanced service or may include new enhanced service.

The broadcast receiving device 60 tunes a channel that a user selects and receives signals of the tuned channel, demodulates the received signals, performs channel decoding and AV decoding on the demodulated signals to generate an uncompressed main AV content, and then, provides the generated uncompressed main AV content to the video display device 100 in operation S206.

Moreover, the content providing server 10 also broadcasts a broadcast signal including a main AV content through a wireless channel in operation S207.

Additionally, the MVPD 30 may directly transmit a broadcast signal including a main AV content to the video display device 100 without going through the broadcast receiving device 60.

The video display device 100 may receive an uncompressed main AV content through the broadcast receiving device 60. Additionally, the video display device 100 may receive a broadcast signal through a wireless channel, and then, may demodulate and decode the received broadcast signal to obtain a main AV content. Additionally, the video display device 100 may receive a broadcast signal from the MVPD 30, and then, may demodulate and decode the received broadcast signal to obtain a main AV content. The video display device 100 extracts feature information from some frames or a section of audio samples of the obtained main AV content in operation S213.

The video display device 100 accesses the fingerprint server 22 corresponding to the predetermined fingerprint server address to transmit a first query including the extracted feature information in operation S215.

The fingerprint server 22 provides a query result as a first reply to the first query in operation S217. If the first reply corresponds to fail, the video display device 100 accesses the fingerprint server 22 corresponding to another fingerprint server address to transmit a first query including the extracted feature information.

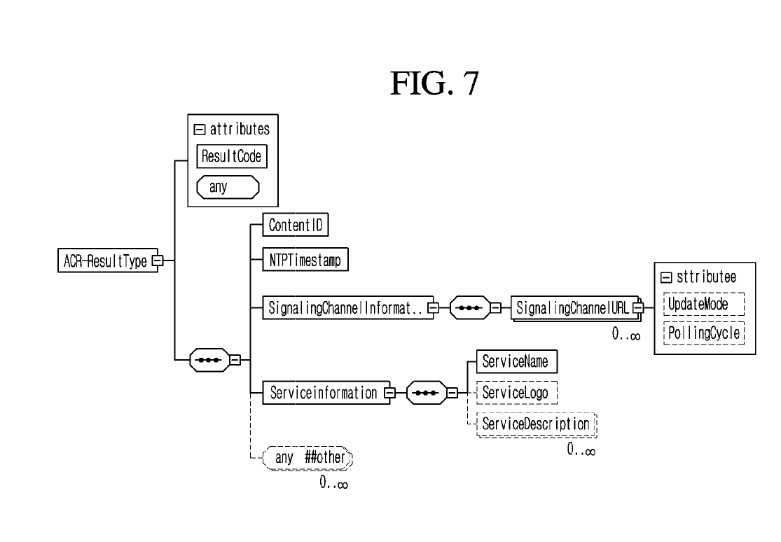

The fingerprint server 22 may provide Extensible Markup Language (XML) document as a query result. Examples of the XML document containing a query result will be described with reference to FIG. 7 and Table 1.

FIG. 7 is a view illustrating an XML schema diagram of ACR-Resulttype containing a query result according to an embodiment.

As shown in FIG. 7, ACR-Resulttype containing a query result includes ResultCode attributes and ContentID, NTPTimestamp, SignalingChannelInformation, and ServiceInformation elements.

For example, if the ResultCode attribute has 200, this may mean that the query result is successful. For example, if the ResultCode attribute has 404, this may mean that the query result is unsuccessful.

The SignalingChannelInformation element includes a SignalingChannelURL, and the SignalingChannelURL element includes an UpdateMode and PollingCycle attributes. The UpdateMode attribute may have a Pull value or a Push value.

The ServiceInformation element includes ServiceName, ServiceLogo, and ServiceDescription elements.

Table 1 illustrates an XML schema of ACR-ResultType containing the query result.

TABLE 1
<xs:complexType name=“ACR-ResultType”>

<xs:sequence>
<xs:element name=“ContentID” type=“xs:anyURI”/>
<xs:element name=“NTPTimestamp” type=“xs:unsignedLong”/>
<xs:element name=“SignalingChannelInformation”>

<xs:complexType>

<xs:sequence>

<xs:element name=“SignalingChannelURL”

maxOccurs=“unbounded”>

<xs:complexType>

<xs:simpleContent>

<xs:extension base=“xs:anyURI”>

<xs:attribute
name=“UpdateMode”>

<xs:simpleType>

<xs:restriction
base=“xs:string”>

<xs:enumeration
value=“Pull”/>
<xs:enumeration
value=“Push”/>

</xs:restriction>

</xs:simpleType>

</xs:attribute>
<xs:attribute name=“PollingCycle”

type=“xs:unsignedInt”/>

</xs:extension>

</xs:simpleContent>

</xs:complexType>

</xs:element>

</xs:sequence>

</xs:complexType>

</xs:element>
<xs:element name=“ServiceInformation”>

<xs:complexType>

<xs:sequence>

<xs:element name=“ServiceName” type=“xs:string”/>
<xs:elemnent name=“ServiceLogo” type=“xs:anyURI”

minOccurs=“0”/>

<xs:element name=“ServiceDescription”
type=“xs:string”

minOccurs=“0” maxOccurs=“unbounded”/>

</xs:sequence>

</xs:complexType>

</xs:element>
<xs:any namespace=“##other” processContents=“skip”
minOccurs=“0”

maxOccurs=“unbounded”/>

</xs:sequence>
<xs:attribute name=“ResultCode” type=“xs:string”
use=“required”/>
<xs:anyAttribute processContents=“skip”/>

</xs:complexType>

As the ContentID element, an ATSC content identifier may be used as shown in Table 2.

TABLE 2

| Syntax | The Number of bits | format |
|---|---|---|
| ATSC_content_identifier( ) { | 16 | uimsbf |
| TSID | 2 | bslbf |
| reserved | 5 | uimsbf |
| end_of_day | 9 | uimsbf |
| unique_for | var | |
| content_id | | |
| } | | |

As shown in Table 2, the ATSC content identifier has a structure including TSID and a house number.

The 16 bit unsigned integer TSID carries a transport stream identifier.

The 5 bit unsigned integer end_of_day is set with an hour in a day of when a content_id value can be reused after broadcasting is finished.

The 9 bit unsigned integer unique_for is set with the number of day of when the content_id value cannot be reused.

Content_id represents a content identifier. The video display device 100 reduces unique_for by 1 in a corresponding time to end_of_day daily and presumes that content_id is unique if unique_for is not 0.

Moreover, as the ContentID element, a global service identifier for ATSC-M/H service may be used as described below.

The global service identifier has the following form.
urn:oma:bcastiauth:atsc:service:<region>:<xsid>:<serviceid>

Here, <region> is an international country code including two characters regulated by ISO 639-2. <xsid> for local service is a decimal number of TSID as defined in <region>, and <xsid>(regional service) (major >69) is “0”. <serviceid> is defined with <major> or <minor>. <major> represent a Major Channel number, and <minor> represents a Minor Channel Number.

Examples of the global service identifier are as follows.
urn:oma:bcast:iauth:atsc:service:us:1234:5.1
urn:oma:bcast:iauth:atsc:service:us:0:100.200

Moreover, as the ContentID element, an ATSC content identifier may be used as described below.

The ATSC content identifier has the following form.
urn:oma:bcastiauth:atsc:content:<region>:<xsidz>:<contentid>:<unique_for>:<end_of day>

Here, <region> is an international country code including two characters regulated by ISO 639-2. <xsid> for local service is a decimal number of TSID as defined in <region>, and may be followed by “.”<serviceid>. <xsid> for (regional service) (major >69) is <serviceid>. <content_id> is a base64 sign of a content_id field defined in Table 2, <unique_for> is a decimal number sign of an unique_for field defined in Table 2, and <end_of day> is a decimal number sign of an end_of_day field defined in Table 2.

Hereinafter, FIG. 6 is described again.

If the query result does not include an enhanced service address or enhanced service but includes an enhanced service address providing server address, the video display device 100 accesses the enhanced service information providing server 40 corresponding to the obtained enhanced service address providing server address to transmit a second query including content information in operation S219.

The enhanced service information providing server 40 searches at least one available enhanced service relating to the content information of the second query. Later, the enhanced service information providing server 40 provides to the video display device 100 enhanced service information for at least one available enhanced service as a second reply to the second query in operation S221.

If the video display device 100 obtains at least one available enhanced service address through the first reply or the second reply, it accesses the at least one available enhanced service address to request enhanced service in operation S223, and then, obtains the enhanced service in operation S225.

When the UpdateMode attribute has a Pull value, the video display device 100 transmits an HTTP request to the enhanced service providing server 50 through SignalingChannelURL and receives an HTTP reply including a PSIP binary stream from the enhanced service providing server 50 in response to the request. In this case, the video display device 100 may transmit the HTTP request according to a Polling period designated as the PollingCycle attribute. Additionally, the SignalingChannelURL element may have an update time attribute. In this case, the video display device 100 may transmit the HTTP request according to an update time designated as the update time attribute.

If the UpdateMode attribute has a Push value, the video display device 100 may receive update from a server asynchronously through XMLHTTPRequest API. After the video display device 100 transmits an asynchronous request to a server through XMLHTTPRequest object, if there is a change of signaling information, the server provides the signaling information as a reply through the channel. If there is limitation in session standby time, a server generates a session timeout reply and a receiver recognizes the generated timeout reply to transmit a request again, so that a signaling channel between the receiver and the server may be maintained for all time.

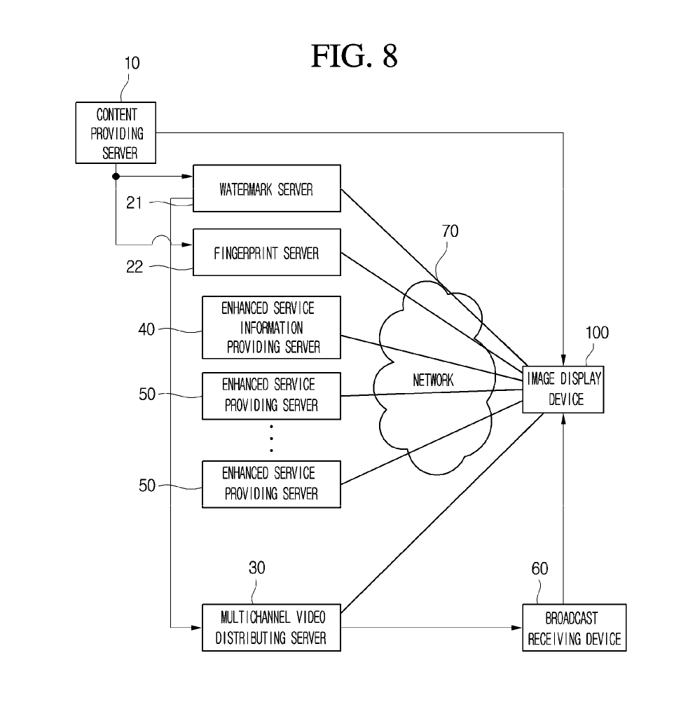

FIG. 8 is a block diagram illustrating a watermark and fingerprint based network topology according to an embodiment.

As shown in FIG. 8, the watermark and fingerprint based network topology may further include a watermark server 21 and a fingerprint server 22.

As shown in FIG. 8, the watermark server 21 inserts content provider identifying information into a main AV content. The watermark server 21 may insert content provider identifying information as a visible watermark such as a logo or an invisible watermark into a main AV content.

The fingerprint server 22 does not edit a main AV content, but extracts feature information from some frames or a certain section of audio samples of the main AV content and stores the extracted feature information. Then, when receiving the feature information from the video display device 100, the fingerprint server 22 provides an identifier and time information of an AV content corresponding to the received feature information.

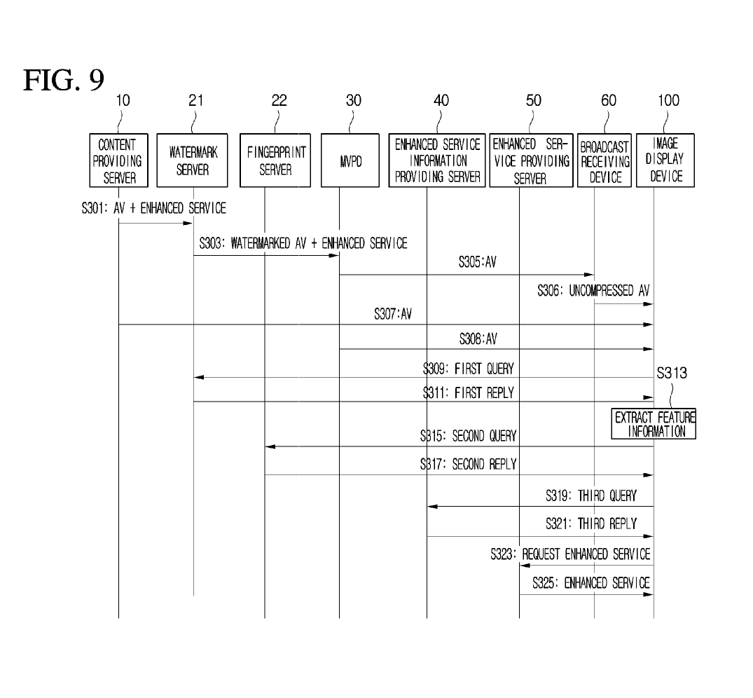

FIG. 9 is a ladder diagram illustrating a data flow in a watermark and fingerprint based network topology according to an embodiment.

First, the content providing server 10 transmits a broadcast signal including a main AV content and an enhanced service in operation S301.

The watermark server 21 receives a broadcast signal that the content providing server 10 provides, inserts a visible watermark such as a logo or watermark information as an invisible watermark into the main AV content by editing the main AV content, and provides the watermarked main AV content and enhanced service to the MVPD 30 in operation S303. The watermark information inserted through an invisible watermark may include at least one of content information, enhanced service information, and an available enhanced service. The content information and enhanced service information are described above.

The MVPD 30 receives broadcast signals including watermarked main AV content and enhanced service and generates a multiplexed signal to provide it to the broadcast receiving device 60 in operation S305. At this point, the multiplexed signal may exclude the received enhanced service or may include new enhanced service.

The broadcast receiving device 60 tunes a channel that a user selects and receives signals of the tuned channel, demodulates the received signals, performs channel decoding and AV decoding on the demodulated signals to generate an uncompressed main AV content, and then, provides the generated uncompressed main AV content to the video display device 100 in operation S306.

Moreover, the content providing server 10 also broadcasts a broadcast signal including a main AV content through a wireless channel in operation S307.

Additionally, the MVPD 30 may directly transmit a broadcast signal including a main AV content to the video display device 100 without going through the broadcast receiving device 60 in operation S308.

The video display device 100 may receive an uncompressed main AV content through the broadcast receiving device 60. Additionally, the video display device 100 may receive a broadcast signal through a wireless channel, and then, may demodulate and decode the received broadcast signal to obtain a main AV content. Additionally, the video display device 100 may receive a broadcast signal from the MVPD 30, and then, may demodulate and decode the received broadcast signal to obtain a main AV content. The video display device 100 extracts watermark information from audio samples in some frames or periods of the obtained main AV content. If watermark information corresponds to a logo, the video display device 100 confirms a watermark server address corresponding to a logo extracted from a corresponding relationship between a plurality of logos and a plurality of watermark server addresses. When the watermark information corresponds to the logo, the video display device 100 cannot identify the main AV content only with the logo. Additionally, when the watermark information does not include content information, the video display device 100 cannot identify the main AV content but the watermark information may include content provider identifying information or a watermark server address. When the watermark information includes the content provider identifying information, the video display device 100 may confirm a watermark server address corresponding to the content provider identifying information extracted from a corresponding relationship between a plurality of content provider identifying information and a plurality of watermark server addresses. In this manner, when the video display device 100 cannot identify a main AV content the video display device 100 only with the watermark information, it accesses the watermark server 21 corresponding to the obtained watermark server address to transmit a first query in operation S309.

The watermark server 21 provides a first reply to the first query in operation S311. The first reply may include at least one of a fingerprint server address, content information, enhanced service information, and an available enhanced service. The content information and enhanced service information are described above.

If the watermark information and the first reply include a fingerprint server address, the video display device 100 extracts feature information from some frames or a certain section of audio samples of the main AV content in operation S313.

The video display device 100 accesses the fingerprint server 22 corresponding to the fingerprint server address in the first reply to transmit a second query including the extracted feature information in operation S315.

The fingerprint server 22 provides a query result as a second reply to the second query in operation S317.

If the query result does not include an enhanced service address or enhanced service but includes an enhanced service address providing server address, the video display device 100 accesses the enhanced service information providing server 40 corresponding to the obtained enhanced service address providing server address to transmit a third query including content information in operation S319.

The enhanced service information providing server 40 searches at least one available enhanced service relating to the content information of the third query. Later, the enhanced service information providing server 40 provides to the video display device 100 enhanced service information for at least one available enhanced service as a third reply to the third query in operation S321.

If the video display device 100 obtains at least one available enhanced service address through the first reply, the second reply, or the third reply, it accesses the at least one available enhanced service address to request enhanced service in operation S323, and then, obtains the enhanced service in operation S325.

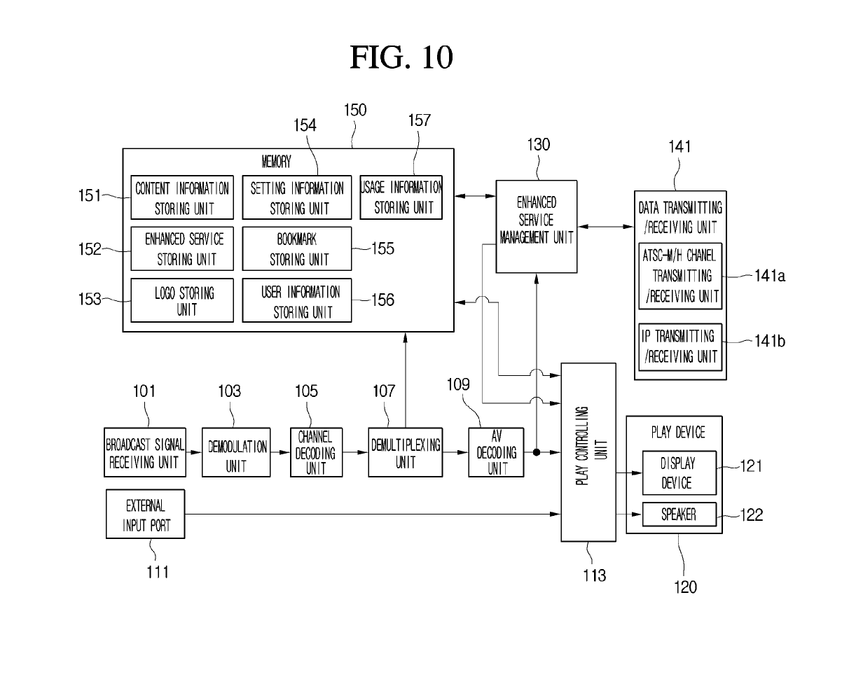

Then, referring to FIG. 10, the video display device 100 will be described according to an embodiment.

FIG. 10 is a block diagram illustrating the video display device according to the embodiment.

As shown in FIG. 10, the video display device 100 includes a broadcast signal receiving unit 101, a demodulation unit 103, a channel decoding unit 105, a demultiplexing unit 107, an AV decoding unit 109, an external input port 111, a play controlling unit 113, a play device 120, an enhanced service management unit 130, a data transmitting/receiving unit 141, and a memory 150.

The broadcast signal receiving unit 101 receives a broadcast signal from the content providing server 10 or MVPD 30.

The demodulation unit 103 demodulates the received broadcast signal to generate a demodulated signal.

The channel decoding unit 105 performs channel decoding on the demodulated signal to generate channel-decoded data.

The demultiplexing unit 107 separates a main AV content and enhanced service from the channel-decoded data. The separated enhanced service is stored in an enhanced service storage unit 152.

The AV decoding unit 109 performs AV decoding on the separated main AV content to generate an uncompressed main AV content.

Moreover, the external input port 111 receives an uncompressed main AV content from the broadcast receiving device 60, a digital versatile disk (DVD) player, a Blu-ray disk player, and so on. The external input port 111 may include at least one of a DSUB port, a High Definition Multimedia Interface (HDMI) port, a Digital Visual Interface (DVI) port, a composite port, a component port, and an S-Video port.

The play controlling unit 113 controls the play device 120 to play at least one of an uncompressed main AV content that the AV decoding unit 109 generates and an uncompressed main AV content received from the external input port 111 according to a user's selection.

The play device 120 includes a display unit 121 and a speaker 123. The display unit 21 may include at least one of a liquid crystal display (LCD), a thin film transistor-liquid crystal display (TFT LCD), an organic light-emitting diode (OLED), a flexible display, and a 3D display.

The enhanced service management unit 130 obtains content information of the main AV content and obtains available enhanced service on the basis of the obtained content information. Especially, as described above, the enhanced service management unit 130 may obtain the identification information of the main AV content on the basis of some frames or a certain section of audio samples the uncompressed main AV content. This is called automatic contents recognition (ACR) in this specification.

The data transmitting/receiving unit 141 may include an Advanced Television Systems Committee-Mobile/Handheld (ATSC-M/H) channel transmitting/receiving unit 141a and an IP transmitting/receiving unit 141b.

The memory 150 may include at least one type of storage medium such as a flash memory type, a hard disk type, a multimedia card micro type, a card type memory such as SD or XD memory, Random Access Memory (RAM), Static Random Access Memory (SRAM), Read-Only Memory (ROM), Electrically Erasable Programmable Read-Only Memory (EEPROM), Programmable Read-Only Memory (PROM), magnetic memory, magnetic disk, and optical disk. The video display device 100 may operate in linkage with a web storage performing a storage function of the memory 150 in the Internet.

The memory 150 may include a content information storage unit 151, an enhanced service storage unit 152, a logo storage unit 153, a setting information storage unit 154, a bookmark storage unit 155, a user information storage unit 156, and a usage information storage unit 157.

The content information storage unit 151 stores a plurality of content information corresponding to a plurality of feature information.

The enhanced service storage unit 152 may store a plurality of enhanced services corresponding to a plurality of feature information or a plurality of enhanced services corresponding to a plurality of content information.

The logo storage unit 153 stores a plurality of logos. Additionally, the logo storage unit 153 may further store content provider identifiers corresponding to the plurality of logos or watermark server addresses corresponding to the plurality of logos.

The setting information storage unit 154 stores setting information for ACR.

The bookmark storage unit 155 stores a plurality of bookmarks.

The user information storage unit 156 stores user information. The user information may include at least one of at least one account information for at least one service, regional information, family member information, preferred genre information, video display device information, and a usage information range. The at least one account information may include account information for a usage information measuring server and account information of social network service such as Twitter and Facebook. The regional information may include address information and zip codes. The family member information may include the number of family members, each member's age, each member's sex, each member's religion, and each member's job. The preferred genre information may be set with at least one of sports, movie, drama, education, news, entertainment, and other genres. The video display device information may include information such as the type, manufacturer, firmware version, resolution, model, OS, browser, storage device availability, storage device capacity, and network speed of a video display device. Once the usage information range is set, the video display device 100 collects and reports main AV content watching information and enhanced service usage information within the set range. The usage information range may be set in each virtual channel. Additionally, the usage information measurement allowable range may be set over an entire physical channel.

The usage information providing unit 157 stores the main AV content watching information and the enhanced service usage information, which are collected by the video display device 100. Additionally, the video display device 100 analyzes a service usage pattern on the basis of the collected main AV content watching information and enhanced service usage information, and stores the analyzed service usage pattern in the usage information storage unit 157.

The enhanced service management unit 130 may obtain the content information of the main AV content from the fingerprint server 22 or the content information storage unit 151. If there is no content information or sufficient content information, which corresponds to the extracted feature information, in the content information storage unit 151, the enhanced service management unit 130 may receive additional content information through the data transmitting/receiving unit 141. Moreover, the enhanced service management unit 130 may update the content information continuously.

The enhanced service management unit 130 may obtain available enhanced service from the enhanced service providing server 50 or the enhanced service storage unit 153. If there is no enhanced service or sufficient enhanced service in the enhanced service storage unit 153, the enhanced service management unit 130 may update enhanced service through the data transmitting/receiving unit 141. Moreover, the enhanced service management unit 130 may update the enhanced service continuously.

The enhanced service management unit 130 may extracts a logo from the main AV content, and then, may make a query to the logo storage unit 155 to obtain a content provider identifier or watermark server address, which is corresponds to the extracted logo. If there is no logo or a sufficient logo, which corresponds to the extracted logo, in the logo storage unit 155, the enhanced service management unit 130 may receive an additional logo through the data transmitting/receiving unit 141. Moreover, the enhanced service management unit 130 may update the logo continuously.

The enhanced service management unit 130 may compare the logo extracted from the main AV content with the plurality of logos in the logo storage unit 155 through various methods. The various methods may reduce the load of the comparison operation.

For example, the enhanced service management unit 130 may perform the comparison on the basis of color characteristics. That is, the enhanced service management unit 130 may compare the color characteristic of the extracted logo with the color characteristics of the logos in the logo storage unit 155 to determine whether they are identical or not.

Moreover, the enhanced service management unit 130 may perform the comparison on the basis of character recognition. That is, the enhanced service management unit 130 may compare the character recognized from the extracted logo with the characters recognized from the logos in the logo storage unit 155 to determine whether they are identical or not.

Furthermore, the enhanced service management unit 130 may perform the comparison on the basis of the contour of the logo. That is, the enhanced service management unit 130 may compare the contour of the extracted logo with the contours of the logos in the logo storage unit 155 to determine whether they are identical or not.

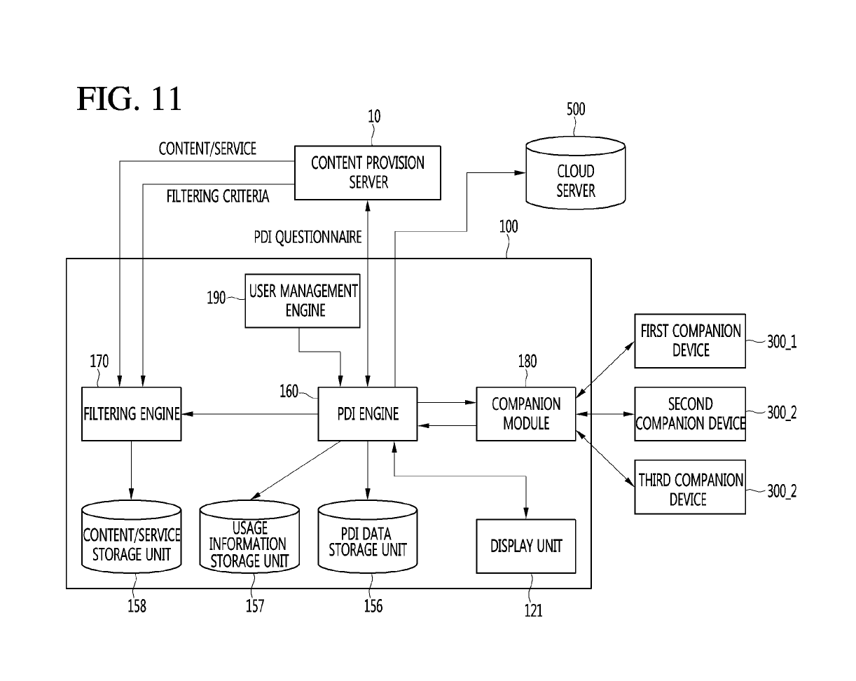

Next, a description will be given with reference to FIG. 11.

FIG. 11 is a diagram showing a digital broadcast system according to an embodiment of the present invention.

According to the embodiment of the present invention, user information includes information on user profile, demographics and interests. Hereinafter, the components of the system will be described.

The user profile, the demographics and the interests are expressed through the answer to a questionnaire. A data structure of summarizing a questionnaire and an answer provided by a specific user is referred to as a profile, demographics and interests (PDI) questionnaire or a PDI table. In the PDI table, a part corresponding to a question is referred to as a PDI question or PDI-Q and a part corresponding to an answer is referred to as a PDI answer or PDI-A. A set of filter criteria is referred to as PDI-filtering criteria.

A receiver available in ATSC 2.0/ATSC 3.0 includes a function for generating an answer (PDI-A instance) corresponding to a question of a questionnaire. The PDI-A generation function is used as input of a PDI-Q instance. The receiver provides a filter function for comparing PDI-FC with PDI-A and determining content to be downloaded and used.

As shown in FIG. 11, the digital broadcast system includes a content provision server 10, a video display apparatus 100, one or more companion devices 300 and a cloud server 500.

The content provision server 10 may correspond to a broadcast station and broadcasts a broadcast signal including main audio-visual content. The content provision server 10 may transmit content, a personalized service, a PDI questionnaire and filtering criteria to the video display apparatus 100. A data structure for summarizing a questionnaire and an answer provided by a specific user may be referred to as PDI questionnaire. According to one embodiment of the present invention, the PDI questionnaire may include information on user profile, demographics and interests. The content provision server 10 includes the functions described with reference to FIGS. 1 to 9.

The video display apparatus 100 may process the content or service, the PDI questionnaire and the filtering criteria received from the content provision server 10. The video display apparatus 100 may include all the components described with reference to FIG. 10.

The video display apparatus 100 may include a PDI engine 160, a filtering engine 170, a PDI data storage unit 156, a content/service storage unit 158, a usage information storage unit 157, a companion module 180 and a display unit 121.

The PDI engine 160 may receive the PDI questionnaire from the content provision server 10 and transmit the PDI, to which a user's answer is applied, to the content provision server 10. The PDI questionnaire may include one or more question items requiring user input. The PDI engine 160 may acquire the PDI questionnaire, to which the received user's answer is applied, from any one of the video display apparatus 100 or the companion device 300. The PDI engine 160 may check whether a questionnaire is pre-stored in the PDI data storage unit 156 and newly store or update the PDI questionnaire according to the checked result. That is, the PDI engine 160 may search the PDI data storage unit 230, update the acquired PDI questionnaire if it is determined that a PDI questionnaire of a specific user is pre-stored and store the acquired PDI questionnaire if it is determined that the PDI questionnaire of the specific user is not pre-stored. The PDI engine 160 may be referred to as a controller.

The filtering engine 170 according to one embodiment of the present invention may filter content based on the PDI questionnaire and the filtering criteria. The filtering criteria refers to one filtering criterion set for filtering only content suitable for a user based on the PDI questionnaire. The filtering engine 170 may receive the PDI questionnaire from the PDI engine 160 and receive the content and the filtering criteria from the content provision server 10.

In addition, the content provision server 10 may transmit the filtering criteria related to the content while transmitting parameters related to declarative content (hereinafter, referred to as content). The filtering engine 170 compares the filtering criteria with the PDI questionnaire and filters and downloads content based on the compared result. The downloaded content may be stored in the content/service storage unit 158.

The display unit 121 displays the PDI questionnaire received from the PDI engine 160 and the PDI answer received from the user in response to the PDI question. The user may transmit the answer to the PDI questionnaire displayed on the video display apparatus 100 through a remote control device such as a remote controller.

The content may be associated with an application executed by the video display apparatus 100 and may include a declarative object, e.g., a triggered declarative object (TDO). In addition, the content may include any one of a video, an image, audio and an application.

The PDI data storage unit 156 stores a PDI questionnaire and PDI data including a PDI questionnaire, to which the received user's answer is applied.

The content/service storage unit 158 stores the filtered content according to the filtering criteria generated based on the PDI questionnaire.

The usage information storage unit 157 stores main audio-visual content viewing information and supplementary service usage information collected by the video display apparatus 100. In addition, the video display apparatus 100 may analyze a service usage pattern based on the collected main audio-visual content viewing information and the collected supplementary service usage information and store the analyzed service usage pattern in the usage information storage unit 157. The usage information storage unit 157 may store content usage information. The content usage information may include at least one of the number of times the user has viewed specific content for a predetermined time, the number of times the user has viewed a specific channel for a predetermined time, the genre of a program viewed by the user for a predetermined time, a program viewed by the user for a predetermined time and a list of content purchased by the user.

The companion module 180 may transmit and receive information to and from the companion device 300 over a network. The companion module 180 may include a short-range communication module such as a Bluetooth, Wi-Fi or ZigBee module.

The companion device 300 may be paired with the video display apparatus 100 to transmit and receive information to and from the video display apparatus 100. The companion device 300 may be a mobile terminal such as a smartphone, a tablet or a laptop.

The cloud server 500 may store the PDI questionnaire and the PDI questionnaire, to which the received user's answer is applied, in a server located outside the video display apparatus 100. The cloud server 500 may receive the PDI questionnaire and the PDI questionnaire, to which the received user's answer is applied, from the PDI engine 160.

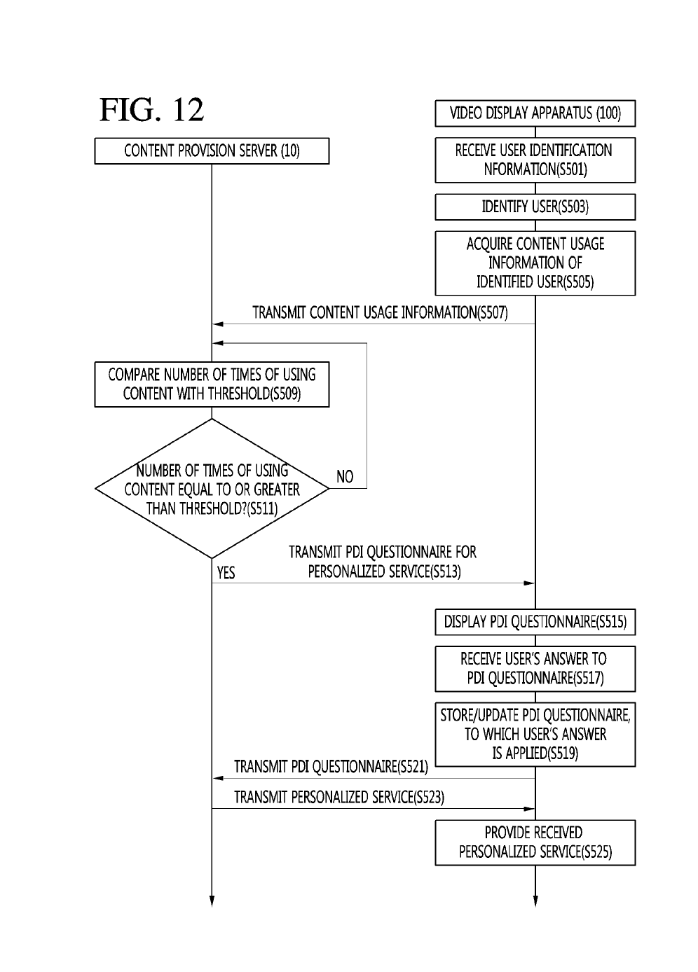

Next, the method of operating the digital broadcast system according to the embodiment of the present invention will be described with reference to FIGS. 12 to 20.

FIG. 12 is a ladder diagram illustrating the method of operating the digital broadcast system including the content provision server 10 and the video display apparatus 100 according to an embodiment of the present invention.

In particular, FIG. 12 shows an embodiment of providing a personalized service without the companion device 300.

A user management engine 190 of the video display apparatus 100 receives user identification information for identifying a user (S501) and identifies the user based on the received user identification information (S503).

In one embodiment, the user management engine 190 may receive an ID and a password for logging in to the video display apparatus 100 from a specific user and identify the user based on the received ID and password.

In another embodiment, the user management engine 190 may receive information on part of the body of the user and identify the user based on the received body information. The part of the body may be any one of the face and fingerprint of the user. If the user is identified using the face of the user, the user management engine 190 may include a camera. If the user is identified through the fingerprint of the user, the remote controller for controlling operation of the video display apparatus 100 may receive the fingerprint of the user. The remote controller may include a fingerprint sensor and transmit the received fingerprint of the user to the video display apparatus 100. The user management engine 190 may identify the user through a process of comparing the received fingerprint of the user with pre-registered fingerprints.

In another embodiment, the user management engine 190 may receive a voice command of the user and identify the user based on the received voice command. The user management engine 190 may store voice commands for identifying users in correspondence with the users. The user management engine 10 may identify the user through a process of comparing the received voice of the user with pre-stored voices.

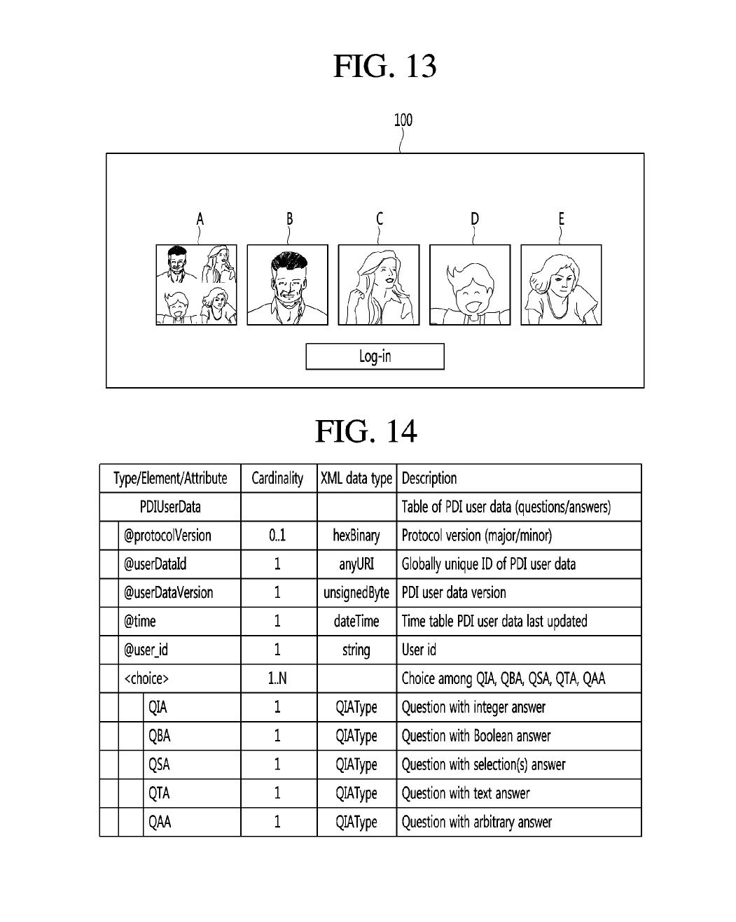

In another embodiment, the user management engine 190 may identify a user or a user group according to a request for selecting an icon. That is, the display unit 121 of the video display apparatus 100 may display a plurality of identification icons when the video display apparatus 100 is powered on. The plurality of identification icons may include a group icon and one or more personal icons. The user management engine 190 may receive a request for selecting any one of the plurality of identification icons and provide a home screen corresponding to the selected icon according to the received request. This will be described with reference to FIG. 13.

FIG. 13 is a diagram showing an example of identifying a user through a plurality of icons and providing a home screen corresponding to the identified user according to an embodiment of the present invention.

FIG. 13 shows an initial screen after the video display apparatus 100 is powered on and before entering a home screen. On the initial screen of the video display apparatus 100, the plurality of icons is displayed. That is, the video display apparatus 100 may display a group icon A, a first user icon B, a second user icon C, a third user icon D and a fourth user icon E on the initial screen. The video display apparatus 100 may receive a request for selecting any one of the plurality of displayed icons and display a home screen corresponding to the selected icon according to the received request. For example, if each user icon is a member, a specific family member may want a home screen suitable therefor. The family member may select an icon corresponding thereto and receive a specific home screen through a login button. If the group icon A is selected, the video display apparatus 100 may display a general home screen. Of course, the family member may receive a home screen corresponding thereto by selecting only an icon without selecting the login button.

On each home screen, preferred content, favorite items, a list of recently viewed or executed content of a family member may be displayed. The family member may receive the home screen suitable therefor by selecting only the icon corresponding thereto.

A description will be given with reference to FIG. 12 again.

The PDI engine 160 of the video display apparatus 100 acquires content usage information of the identified user (S505).

In one embodiment, the content usage information may include at least one of the number of times of viewing a specific channel for a predetermined time, the number of times of viewing a program of a specific genre for a predetermined time, a program viewed by the user for a predetermined time, a list of content purchased by the user and the number of times of executing a specific application.

In one embodiment, the PDI engine 160 may acquire content usage information based on the list of content viewed by the user. That is, the video display apparatus 100 may collect information on content recently viewed by the user and acquire content usage information based on the collected information on the content.

In another embodiment, the PDI engine 160 may acquire content usage information based on cookie information. The cookie information may mean a small record information file stored on a computer of an Internet user by a server of a website.

In another embodiment, the PDI engine 160 may acquire the content usage information based on automatic content recognition (ACR). In this case, the PDI engine 160 may include a supplementary service management unit 130 shown in FIG. 10. More specifically, ACR may include a watermark method or a fingerprint method described with reference to FIGS. 1 to 10. The watermark method refers to a method of modifying main audio-visual content and recognizing content based on a visible watermark such as a logo and an invisible watermark in the main audio-visual content. The fingerprint method refers to a method of recognizing content based on feature information extracted from some audio samples or some frames of main audio-visual content. The PDI engine 160 may acquire the content usage information of the user based on ACR technology.

The PDI engine 160 of the video display apparatus 100 transmits the acquired content usage information of the user to the content provision server 10 (S507).

In one embodiment, the PDI engine 160 may transmit the content usage information to the content provision server 10 in order to receive the PDI questionnaire, based on which the personalized service is received from the content provision server 10.

The content provision server 10 compares the number of times of using the content with a threshold based on the content usage information received from the video display apparatus 100 (S509) and checks whether the number of times of using the content is equal to or greater than the threshold as the compared result (S511).

The number of times of using the content may be one of the number of times of viewing the content or the number of times of downloading or uploading the content. In some cases, the number of times of using the content may include the number of times of accessing a content provider for providing the content.

In one embodiment, the threshold may be a minimum number of times of using the content, which is a criterion used to transmit the PDI questionnaire to the video display apparatus 100. When the user views a program of a specific genre predetermined times or more for a predetermined time, the content provision server 10 may determine that the number of times of using the content satisfies the threshold. For example, when the user views a broadcast of a professional baseball game four times or more for one week, the content provision server 10 may determine that the user is interested in a baseball among kinds of sports and determine that the threshold is satisfied. Here, one week and four times are merely exemplary.

If the number of times of using the content satisfies the threshold, the content provision server 10 transmits the PDI questionnaire for the personalized service to the PDI engine 160 of the video display apparatus 100 (S513).

In one embodiment, the content provision server 10 may transmit the PDI questionnaire to the video display apparatus 100 in order to provide a personalized service to a specific user.

In another embodiment, the content provision server 10 may transmit the PDI questionnaire to the companion device 300 paired with the video display apparatus 100, which will be described below.

The XML schema structure of the PDI questionnaire will be described with reference to FIG. 14.

FIG. 14 is a diagram showing an XML schema table of a PDI questionnaire according to an embodiment of the present invention.

The PDI questionnaire refers to a document obtained by executing the PDI table of the XML schema. The question of the PDI table may be unofficially referred to as a “PDI question” or “PDI-Q”. The answer to the given PDI question may be unofficially referred to as “PDI-A”.

PDI-Q and PDI-A may be acquired by the PDI table including PDI-Q and PDI-A of XML schema. PDI-Q and PDI-A may include types such as QIA (question with integer answer), QBA (question Boolean answer), QSA (question with selection(s) answer), QTA (question with text answer) and QAA (question with arbitrary answer).

As shown in FIG. 14, in order to distinguish between attributes and elements, in the PDI table according to the present embodiment, the element name may be prefixed with “@”.

As shown in FIG. 14, the PDI user data table (hereinafter, PDI table) may include a protocol Version element, a userDataId element, a userDataVersion element, a time element and a user_id element, independently of a question type element. In addition, the PDI table may include one or more question elements. Each question element may be any one of QIA, QBA, QSA, QTA and QAA. 1 . . . N of <choice> means that the question elements appear in arbitrary order.

The protocol Version element of the PDI table may be hexadecimal. Higher 4 bits indicate a major version of a protocol and lower 4 bits indicate a minor version of the protocol. If the major version of the PDI table is set to 1, the receiver such as the video display apparatus 100 may determine that a PDI specified by the major version which is not supported by the receiver is discarded and, if the minor version of the PDI table is set to 0, the receiver may determine that a PDI specified by the minor version which is not supported by the receiver is not discarded. In this case, the receiver may determine that each element which is not supported by the receiver may be ignored.

The userDataId element of the PDI table may be a global unique identifier of PDI user data.

The userDataVersion element of the PDI table may be the version of the PDI user data and may have a value of 0 to 255. As the userDataVersion increases by 1, another user may be indicated.

The time element of the PDI table may indicate a recent change time of a question in the PDI table.

The user_id element of the PDI table may be an identifier for identifying the user of the table. The video display apparatus 100 may identify the PDI questionnaire acquired from a plurality of users through the user_id.

The QIA element indicates a question with an integer answer. The QIA element may include information for selectively restricting minimum and maximum allowable values of the answer.

The QBA element indicates a question with a Boolean answer.

The QSA element indicates a question with a selection answer. The QSA element may include a QSA.minchoice element and the QSA.minchoice element may specify a minimum number selectable by a user. In addition, the QSA element may include a QSA.maxchoice element and the QSA.maxchoice element indicates a maximum number selectable by a user.

The QTA element indicates a question with a text answer.

The QAA element indicates a question with an arbitrary (free style) answer.

A description is given with reference to FIG. 12 again.

The display unit 121 of the video display apparatus 100 displays the PDI questionnaire received from the content provision server 10 (S515).

In one embodiment, the PDI engine 160 may control the display unit 121 to display the PDI questionnaire received from the content provision server 10 while the user views content.

In another embodiment, the PDI questionnaire received from the content provision server 10 may be set to be or not to be displayed. For example, if the user sets the PDI questionnaire not to be displayed, the video display apparatus 100 may not display the PDI questionnaire even upon receiving the PDI questionnaire from the content provision server 10. If the user sets the PDI questionnaire to be displayed, the video display apparatus 100 may immediately display the received PDI questionnaire when receiving the PDI questionnaire from the content provision server 10.

In another embodiment, the PDI engine 160 may control the display unit 121 such that the PDI questionnaire is not displayed and an indicator indicating that the PDI questionnaire has been received is displayed at one side of the screen when the PDI questionnaire is received from the content provision server 10. When a request for selecting the indicator is received, the PDI engine 160 may control the display unit 121 to display the PDI questionnaire received from the content provision server 10.

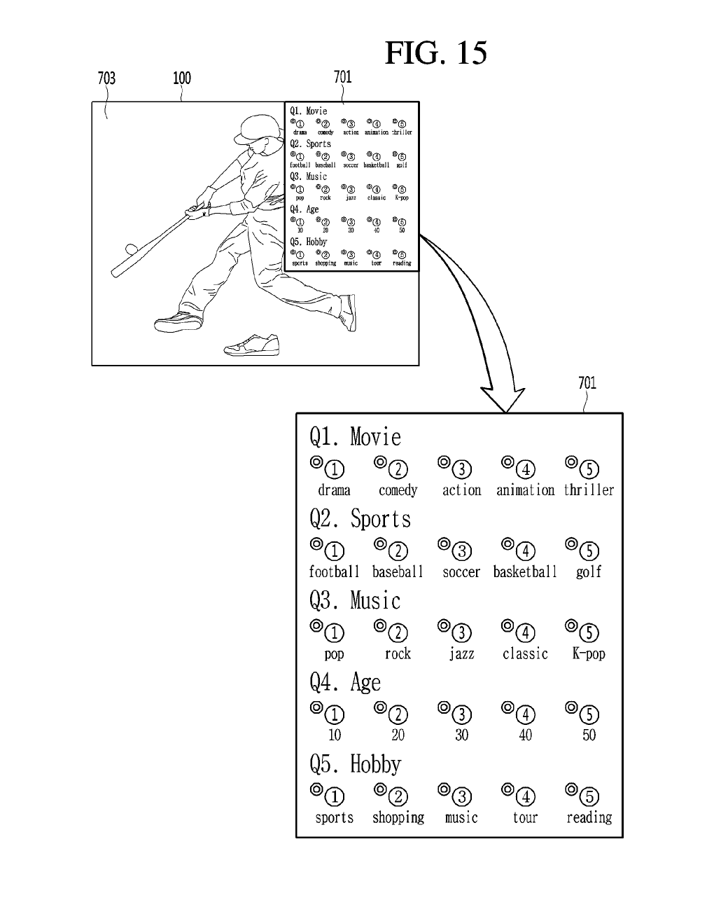

Step S515 will be described with reference to FIGS. 15 to 17.

FIGS. 15 to 17 are diagrams illustrating an example in which the video display apparatus displays the PDI questionnaire received from the content provision server according to an embodiment of the present invention.

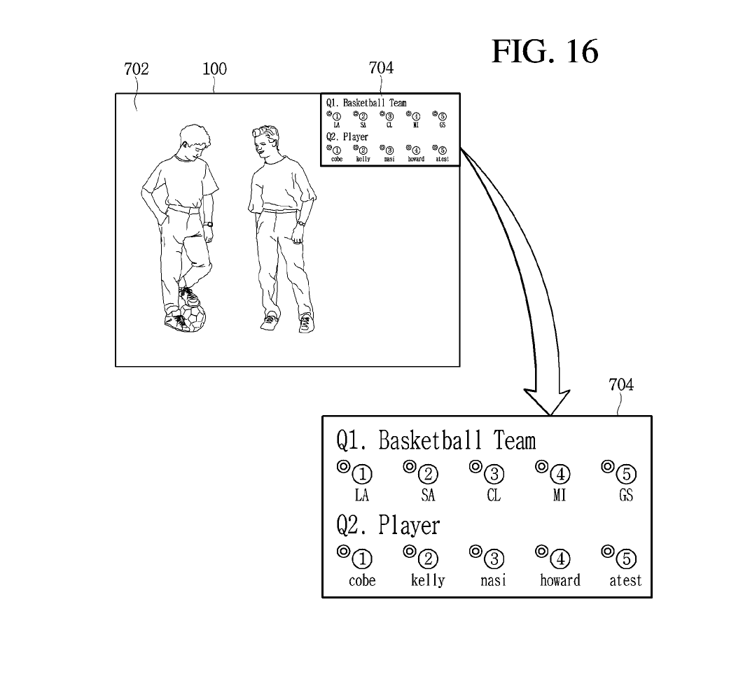

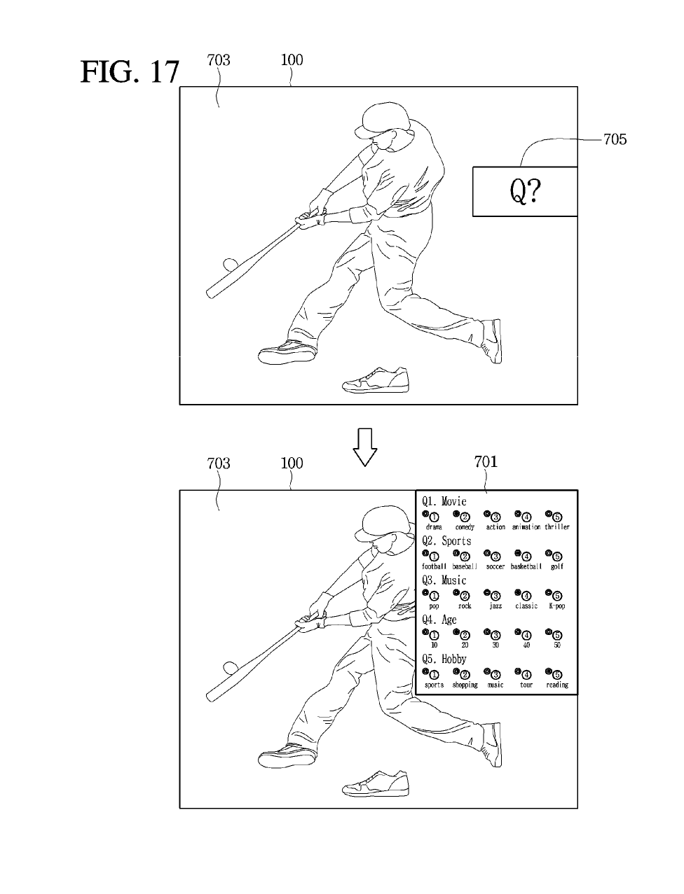

In particular, FIGS. 15 and 16 are diagrams showing the video display apparatus 100 displaying the PDI questionnaire and FIG. 17 is a diagram showing an indicator indicating that the PDI questionnaire has been received.

Referring to FIG. 15, the PDI engine 160 of the video display apparatus 100 may display the PDI questionnaire 701 received from the content provision server 10 at one side of the display unit 121. That is, the PDI engine 160 of the video display apparatus 100 may display the PDI questionnaire 701 at one side of the screen in the form of a popup window when the PDI questionnaire 701 is received from the content provision server 10 while specific content 703 (e.g., real-time broadcast program) is displayed on the screen. The specific content displayed on the screen may be a broadcast program related to baseball. If the number of times of viewing the broadcast program related to baseball is equal to or greater than the threshold, the video display apparatus 100 may display the PDI questionnaire 701 on the display unit 121.

The PDI questionnaire 701 may be displayed on the full screen of the display unit 121 through user input using the remote controller.

The PDI engine 160 may place the PDI questionnaire 701 in a specific area so as not to interrupt viewing of content which is being displayed on the screen. More specifically, the PDI engine 160 may recognize content which is being displayed on the screen and place the PDI questionnaire 701 in a specific area of the screen so as not to conceal major persons or objects of the content.

The PDI questionnaire 701 may include one or more question items. The question items shown in FIG. 15 may include a movie item, a sports item, a music item, an age item, and a hobby item. The movie item has movie genre options 1 to 5. The sports item has sports type options 1 to 5. The music item has music genre options 1 to 5. The age item has age group options 1 to 5. The hobby item has hobby type options 1 to 5. The user may give an answer to each item of the PDI questionnaire 701 according to key input of the remote control device such as the remote controller or may end the PDI questionnaire 701 without giving an answer to the PDI questionnaire 701.

Next, a description will be given with reference to FIG. 16.

According to another embodiment of the present invention, the PDI questionnaire 704 may include items related to content, the number of times of use of which is equal to or greater than the threshold. More specifically, upon determining that the user has viewed a broadcast of a basketball game predetermined times or more for a predetermined time, the PDI questionnaire 704 may include items related to basketball. That is, the PDI questionnaire 704 may include a basketball team item and a basketball player item. The video display apparatus 100 may receive related content based on the answer of the user to the PDI questionnaire 704, which will be described in detail below.

Next, a description will be given with reference to FIG. 17.

Referring to FIG. 17, the PDI engine 160 of the video display apparatus 100 may display an indicator 705 indicating that the PDI questionnaire 701 has been received from the content provision server 10 at one side of the display unit 121. That is, the PDI engine 160 of the video display apparatus 100 may display the indicator 705 indicating that the PDI questionnaire 701 has been received from the content provision server 10 at one side of the screen while displaying specific content 703 (e.g., real-time broadcast program) on the screen. When a request for selecting the indicator 705 is received from the remote controller, the PDI engine 160 may display the PDI questionnaire 701 at one side of the screen as shown in FIG. 15.

A description will be given with reference to FIG. 12 again.

The user management engine 190 of the video display apparatus 100 receives a user's answer to the displayed PDI questionnaire (S517).

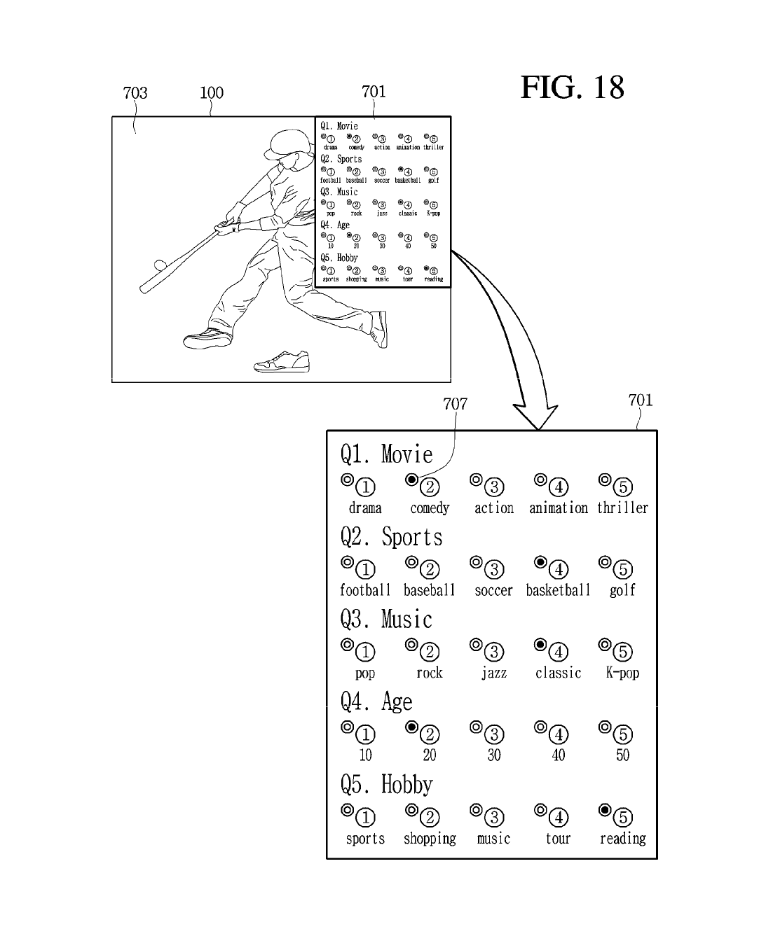

In one embodiment, the user management engine 190 may receive user selection input with respect to each item of the PDI questionnaire through the remote controller. Step S517 will be described with reference to FIG. 18.

FIG. 18 is a diagram illustrating a process of receiving an answer of a user in response to a PDI questionnaire according to an embodiment of the present invention.

Referring to FIG. 18, it can be seen that, in the movie item, a comedy genre has been selected through input using the remote controller. Similarly, basketball may be selected in the sports item, classical may be selected in the music item, twenties may be selected in the age item, and reading may be selected in the hobby item. The video display apparatus 100 may provide content suitable for the user based on the user's answer to the PDI questionnaire 701 from the content provision server 10.

A description will be given with reference to FIG. 12 again.

The PDI engine 160 of the video display apparatus 100 stores or updates the PDI questionnaire, to which the received user's answer is applied (S519).

The PDI engine 160 may store the PDI questionnaire, to which the user's answer is applied, in the PDI data storage unit 156, if the PDI questionnaire of the user is not stored in the PDI data storage unit 156.

The PDI engine 160 may newly store the PDI questionnaire, to which the user's answer is applied, in the PDI data storage unit 156, if the PDI questionnaire of the user is stored in the PDI data storage unit 156.

In one embodiment, if the PDI questionnaire of a specific user is stored, the PDI engine 160 may not display the PDI questionnaire even when the number of times of using the content exceeds the threshold.

The PDI engine 160 of the video display apparatus 100 transmits the PDI questionnaire, to which the user's answer is applied, to the content provision server 10 (S521) and the content provision server 10 transmits a personalized service to the video display apparatus 10 based on the PDI questionnaire, to which the user's answer is applied, received from the video display apparatus 100 (S523).

In one embodiment, the content provision server 10 may transmit customized content to the user based on the PDI questionnaire, to which the user's answer is applied. For example, the customized content may be a target advertisement. That is, the content provision server 10 may transmit an advertisement targeted at the user to the video display apparatus 100 based on the options selected in the items included in the PDI questionnaire.

In another example, the customized content may be a recommended program. That is, the content provision server 10 may transmit information on a recommended program suitable for the user to the video display apparatus 100 based on the options selected in the items included in the PDI questionnaire.

The PDI engine 160 of the video display apparatus 100 provides the personalized service received from the content provision server 10 (S515).

In one embodiment, if the personalized service received from the content provision server 10 is a target advertisement, the PDI engine 160 may display the received target advertisement at an advertisement broadcast time.

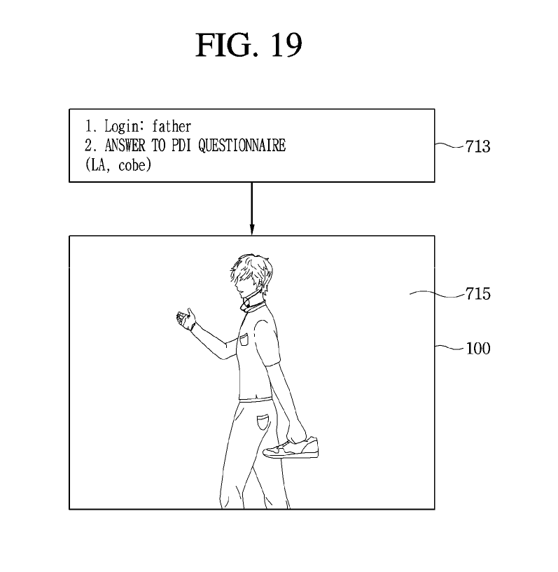

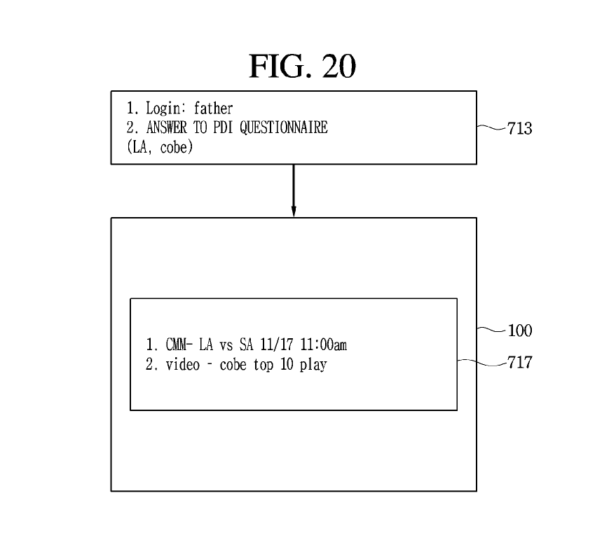

In another embodiment, if the personalized service received from the content provision server 10 is recommended content information, the PDI engine 160 may display a recommended content list, which will be described with reference to FIGS. 19 to 20.

FIGS. 19 to 20 are diagrams illustrating examples of providing a personalized service according to various embodiments of the present invention.

In particular, FIG. 19 shows an embodiment of providing a target advertisement as a personal service and FIG. 20 shows an embodiment of providing a recommended content list.

Assume that the PDI questionnaire used in FIGS. 19 and 20 is equal to that of FIG. 16.

Based on the PDI questionnaire, to which the user's answer is applied, the content provision server 10 may generate a PDI questionnaire result 713. The PDI questionnaire result 713 shows that the user logging in to the video display apparatus 100 is a father and a basketball team “LA” and a basketball player “cobe” are selected as options of the items included in the PDI questionnaire.

The content provision server 10 may transmit a target advertisement, in which the player “cobe” of the basketball team “LA” appears, to the video display apparatus 100 based on the PDI questionnaire result 713. The video display apparatus 100 may display the target advertisement received from the content provision server 10 at an advertisement broadcast time, as shown in FIG. 19.

The content provision server 10 may transmit recommended content related to the player “cobe” of the basketball team “LA” to the video display apparatus 100 based on the PDI questionnaire result 713. The video display apparatus 100 may display a recommended content list 717 based on the recommended content information received from the content provision server 10, as shown in FIG. 20. The recommended content list may include the scheduled broadcast of the basketball game of the team, to which the player “cobe” belongs, and a URL address capable of viewing videos of top 10 plays of the player “cobe”.

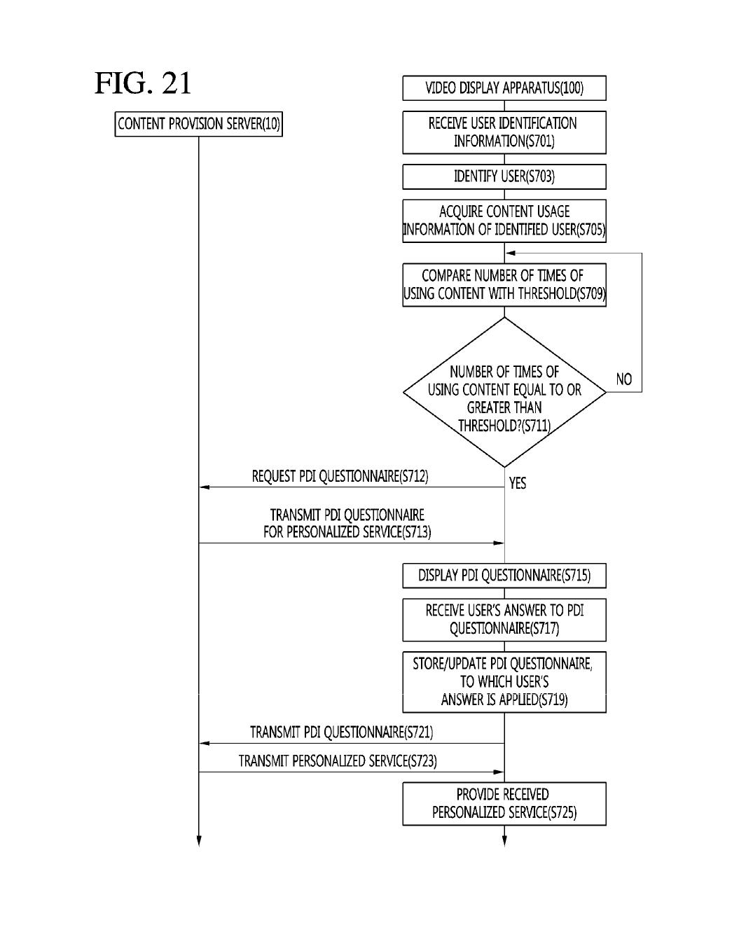

Next, a method of operating a digital broadcast system according to another embodiment of the present invention will be described with reference to FIG. 21.

FIG. 21 is a ladder diagram illustrating a method of operating a digital broadcast system according to another embodiment of the present invention.

The same portions of the method of operating the digital broadcast system of FIG. 21 as the method of FIG. 12 will be omitted. That is, steps S501 to S505 of FIG. 12 are equal to steps S701 to S705 of FIG. 21 and step S515 to S525 of FIG. 12 are equal to step S715 to S725 of FIG. 21.

Steps S709 to S713 are different from steps of the method of FIG. 12 in that the entity for performing steps S709 to S711 is changed from the content provision server 10 to the video display apparatus 100.

Hereinafter, steps S709 to S713 will be described.

The PDI engine 160 of the video display apparatus 100 compares the number of times of using the content with the threshold based on the usage information of the acquired content (S709) and checks whether the number of times of using the content is equal to or greater than the threshold as the compared result (S711).

If the number of times of using the content is equal to or greater than the threshold, the PDI engine 160 of the video display apparatus 100 requests the PDI questionnaire for the personalized service from the content provision server 10 (S712).

In one embodiment, the PDI engine 160 of the video display apparatus 100 may transmit, to the content provision server 10, the request including information indicating that the number of times of using the content is equal to or greater than the threshold.

The content provision server 10 transmits the PDI questionnaire to the video display apparatus 100 in response to the request for the PDI questionnaire received from the video display apparatus 100 (S713).

The subsequent steps are equal to those of FIG. 12.

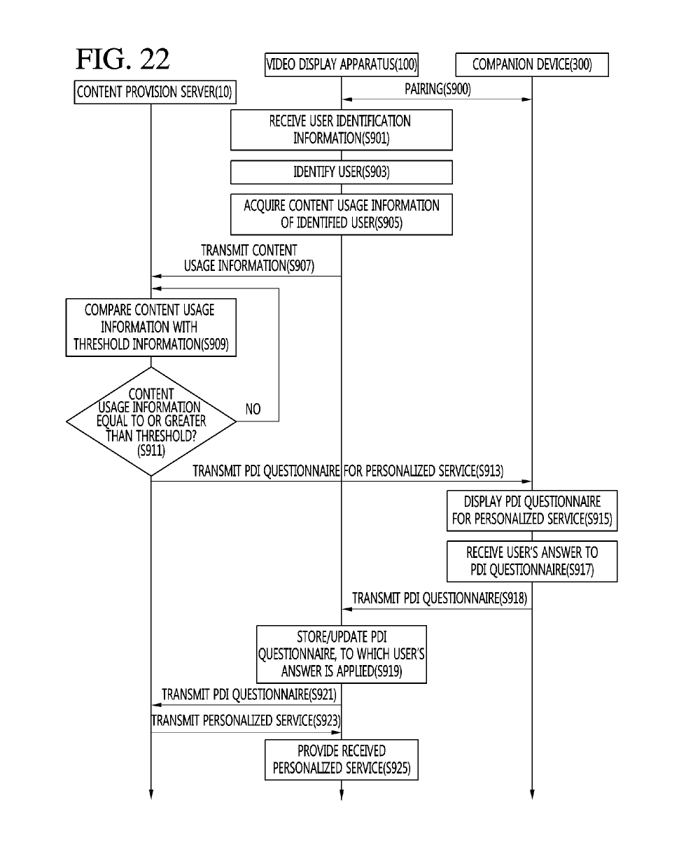

Next, a description will be given with reference to FIG. 22.

FIG. 22 is a ladder diagram illustrating a method of operating a digital broadcast system according to another embodiment of the present invention.

A detailed description of the same steps of FIG. 22 as FIG. 12 will be omitted.

The digital broadcast system according to the embodiment of the present invention of FIG. 22 may include a content provision server 10, a video display apparatus 100 and a companion device 300.

The video display apparatus 100 and the companion device 300 are paired (S900).

In one embodiment, the video display apparatus 100 and the companion device 300 may be paired through short-range wireless communication. The short-range wireless communication may be any one of Bluetooth, Wi-Fi or ZigBee, which are merely exemplary.

The user management engine 190 of the video display apparatus 100 receives user identification information for identifying the user (S901) and identifies the user based on the received user identification information (S903).

The PDI engine 160 of the video display apparatus 100 acquires content usage information of the identified user (S905).

The PDI engine 160 of the video display apparatus 100 transmits the acquired content usage information of the user to the content provision server 10 (S907).

The content provision server 10 compares the number of times of using the content with the threshold based on the content usage information received from the video display apparatus 100 (S909) and checks whether the number of times of using the content is equal to or greater than the threshold as the compared result (S911).

If the number of times of using the content satisfies the threshold, the content provision server 10 transmits the PDI questionnaire for the personalized service to the companion device (S913).

In one embodiment, the content provision server 10 may transmit the PDI questionnaire to the companion device 300 paired with the video display apparatus 100. The content provision server 10 may pre-receive a request for transmitting the PDI questionnaire to the companion device 300 paired with the video display apparatus 100 from the video display apparatus 100. This request may be transmitted to the content provision server 10 along with the content usage information of step S907. The request may include the identifier of the companion device 300 interworking with the video display apparatus 100.

The companion device 300 displays the PDI questionnaire received from the content provision server 10 (S915).

The companion device 300 receives a user's answer to the PDI questionnaire (S917) and transmits the PDI questionnaire, to which the user's answer is applied, to the video display apparatus 100 (S918).

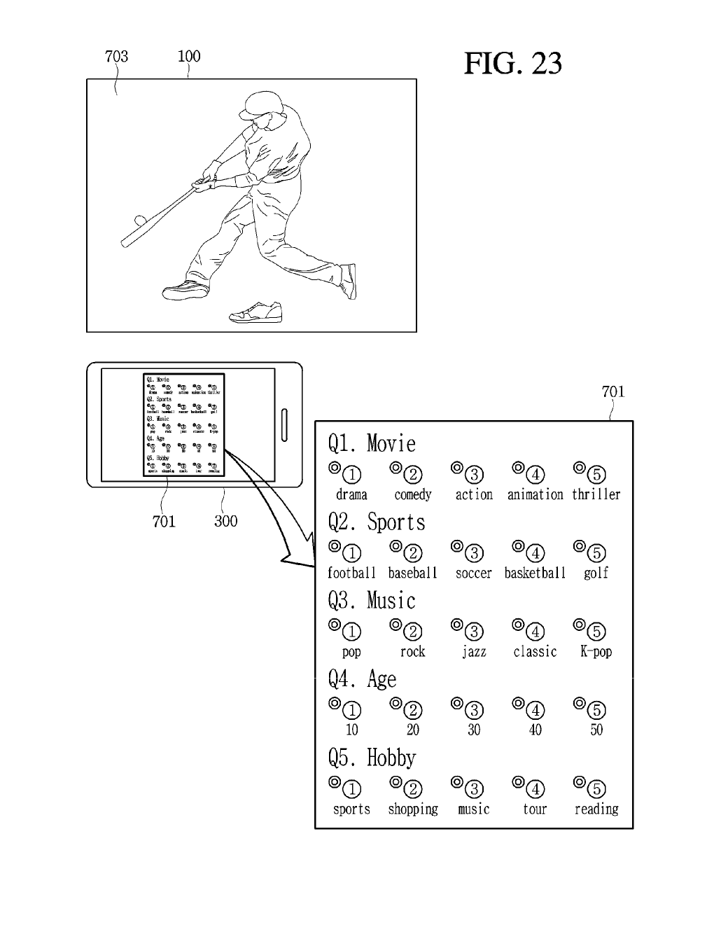

Steps S915 to S918 will be described with reference to FIGS. 23 to 25.

FIGS. 23 to 25 are diagrams illustrating examples in which the companion device displays the PDI questionnaire received from the content provision server according to an embodiment of the present invention.

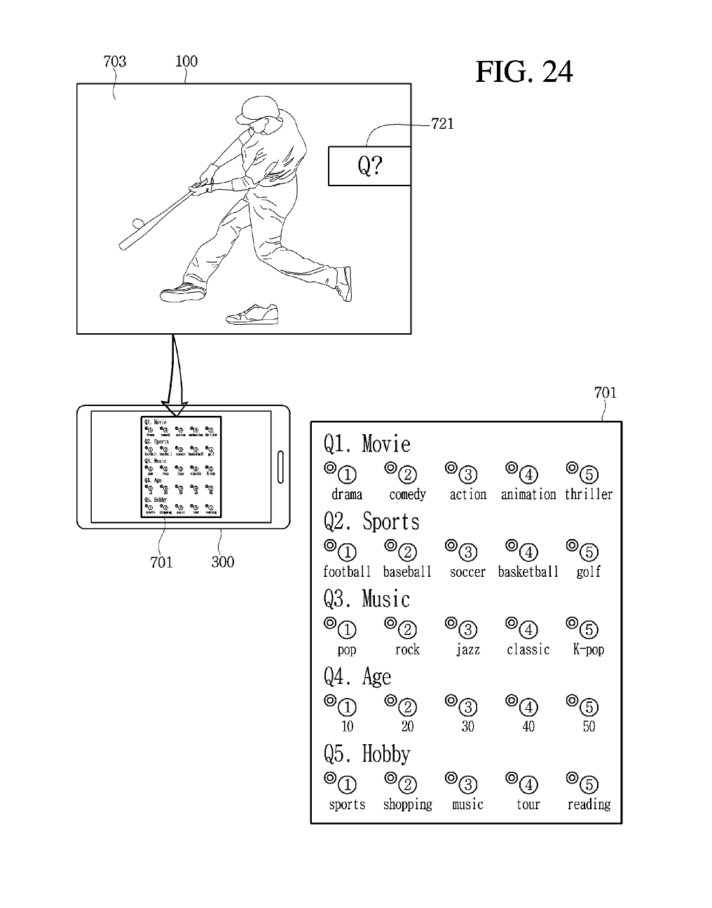

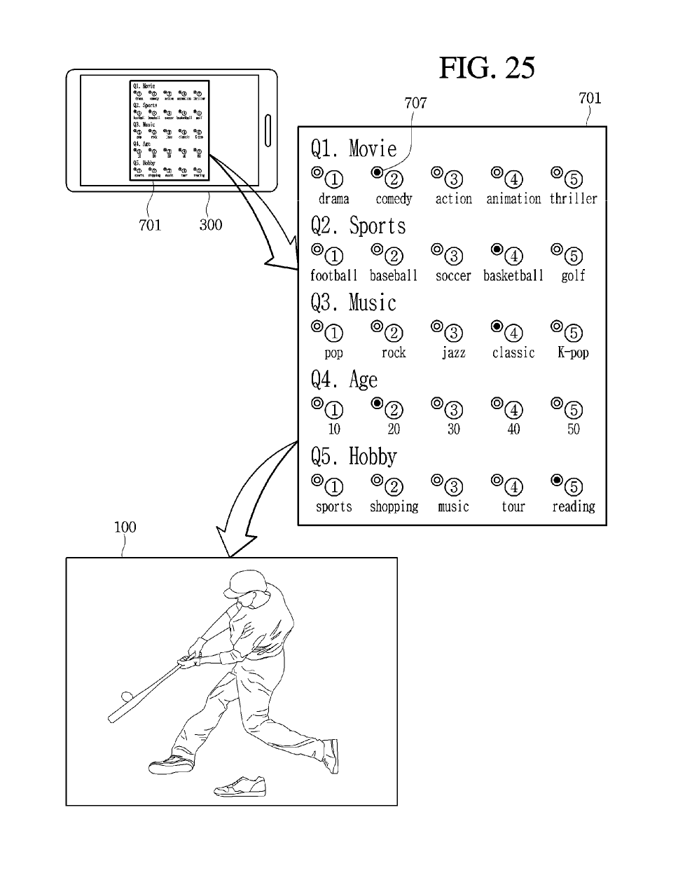

FIGS. 23 and 24 are diagrams showing the companion device 300 displaying the PDI questionnaire and FIG. 25 is a diagram showing a process of, at the companion device 300, inputting the user's answer to the PDI questionnaire.

First, referring to FIG. 23, if it is determined that the number of times of using the content exceeds the threshold while the user views the content 703 which is being displayed on the screen of the video display apparatus 100, the content provision server 10 may transmit the PDI questionnaire 701 to the companion device 300 paired with the video display apparatus 100. As another example, upon determining that the number of times of using the content exceeds the threshold while the user views the content 703 which is being displayed on the screen of the video display apparatus 100, the content provision server 10 may transmit the PDI questionnaire to the video display apparatus 100. The video display apparatus 100 may deliver the received PDI questionnaire to the companion device 300.

Referring to FIG. 24, if it is determined that the number of times of using the content exceeds the threshold while the user views the content 703 which is being displayed on the screen of the video display apparatus 100, the content provision server 10 may display an indicator 721 indicating that the PDI questionnaire has been generated at one side of the screen of the video display apparatus 100. When the video display apparatus 100 receives a request for selecting the indicator 721, the companion device 300 may receive and display the PDI questionnaire from the content provision server 100.

Referring to FIG. 25, if the companion device 300 includes a touchscreen, it can be seen that the comedy genre has been selected in the movie item through touch input. Similarly, a basketball may be selected in the sports item, a classic may be selected in the music item, twenties may be selected in the age item, and reading may be selected in the hobby item. The companion device 300 may transmit the PDI questionnaire, to which the user's answer is applied, to the video display apparatus 100.

The PDI engine 160 of the video display apparatus 100 stores or updates the PDI questionnaire, to which the user's answer is applied, received from the companion device 300 (S919).

The PDI engine 160 of the video display apparatus 100 transmits the PDI questionnaire, to which the user's answer is applied, to the content provision server 10 (S921) and the content provision server 10 transmits the personalized service to the video display apparatus 100 based on the PDI questionnaire, to which the user's answer is applied, received from the video display apparatus 100 (S923).

The PDI engine 160 of the video display apparatus 100 provides the personalized service received from the content provision server 10 (S925).

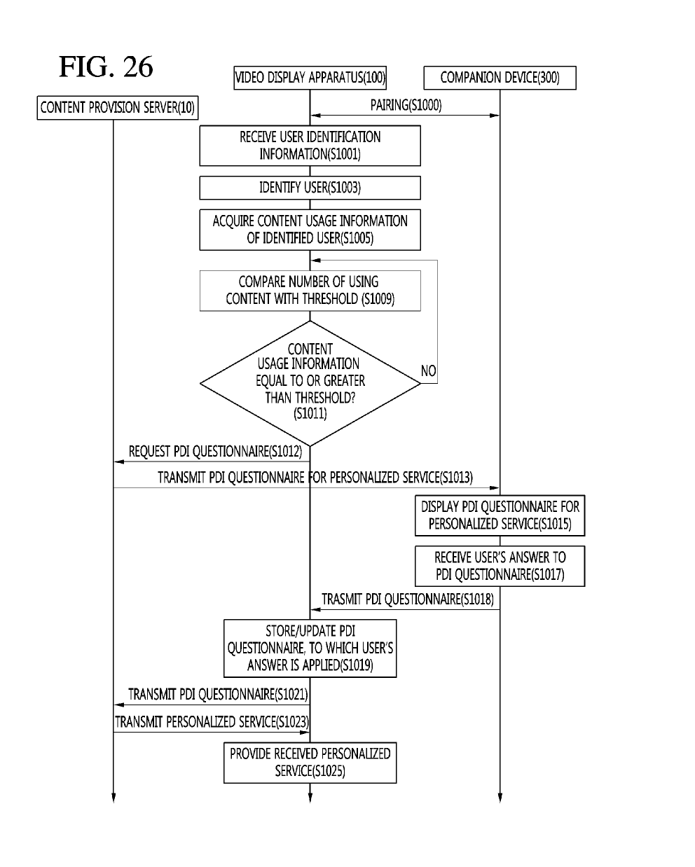

Next, a description will be given with reference to FIG. 26.

FIG. 26 is a ladder diagram illustrating a method of operating a digital broadcast system according to another embodiment of the present invention.

In the embodiment of FIG. 26, the same steps as FIG. 25 will be omitted. FIG. 26 is different from FIG. 25 in Steps S1009 to S1013. In particular, the entity for performing steps S1009 to S1011 is changed from the content provision server 10 to the video display apparatus 100.

Hereinafter, steps S1009 to S1013 will be described.

The PDI engine 160 of the video display apparatus 100 compares the number of times of using the content with the threshold based on the acquired content usage information and checks whether the number of times of using the content is equal to or greater than the threshold as the compared result (S1011).

If the number of times of using the content is equal to or greater than the threshold, the PDI engine 160 of the video display apparatus 100 requests the PDI questionnaire for the personalized service from the content provision server 10 (S1012).

In one embodiment, the PDI engine 160 of the video display apparatus 100 may transmit the request including information indicating that the number of times of using the content is equal to or greater than the threshold to the content provision server 10.

The content provision server 10 transmits the PDI questionnaire to the companion device 300 paired with the video display apparatus 100 in response to the request for the PDI questionnaire received from the video display apparatus 100 (S1013).

The subsequent steps thereof are equal to those of FIG. 25.

The personalized service transmitted from the content provision server 10 to the video display apparatus 100 or the companion device may include target advertisement content. Hereinafter, although it is assumed that the content provision server 10 transmits advertisement content to the video display apparatus 100, the content provision server 10 may transmit the advertisement content to the companion device 300.

The content provision server 10 may simultaneously transmit a plurality of pieces of advertisement content having the same time frame or time interval to the video display apparatus 100. The content provision server 10 may be any one of a broadcaster or a content provider. The video display apparatus 100 may display any one of the plurality of pieces of advertisement content received from the content provision server 10 based on the content usage information of the user.

In one embodiment, the video display apparatus 100 may display any one of the plurality of pieces of advertisement content received from the content provision server 10 based on the result of comparing the number of times of using the content with the threshold. For example, if it is determined that a first user logs in to the video display apparatus 100 and has viewed a broadcast of a basketball game four times in one week, the video display apparatus 100 may display an advertisement for basketball shoes among the plurality of pieces of received advertisement content at an advertisement display time. If it is determined that a second user logs in to the video display apparatus 100 and has viewed a home shopping broadcast four times for one week, the video display apparatus 100 may display an advertisement related to shopping among the plurality of pieces of received advertisement content at an advertisement display time.

In another embodiment, the video display apparatus 100 may display any one of the plurality of pieces of advertisement content received from the content provision server 10 based on the user's answer to the PDI questionnaire. That is, the video display apparatus 100 may display advertisement content related to an option selected by the user in each item at an advertisement display time based on the PDI questionnaire stored in the PDI data storage unit 156 among the plurality of pieces of advertisement content.

If the plurality of pieces of advertisement content is transmitted through a hybrid broadcast which is a combination of a satellite broadcast and an IP broadcast or a combination of a terrestrial broadcast and an IP broadcast, the content provision server 10 may provide the plurality of pieces of advertisement content through an internal protocol (IP) network.

When the content provision server 10 simultaneously transmits the plurality of pieces of advertisement content having the same time frame to the video display apparatus 100, the video display apparatus 100 may provide customized advertisement content to each user, thereby obtaining positive advertisement effects.

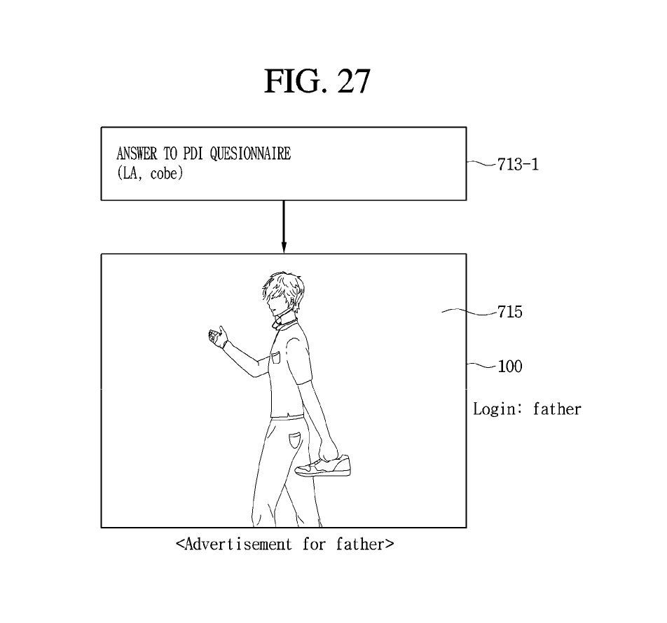

An embodiment in which the video display apparatus provides different advertisement content to each user will be described with reference to FIGS. 27 to 29.

FIGS. 27 to 29 are diagrams illustrating examples in which a video display apparatus provides different advertisement content to each user according to an embodiment of the present invention.

In particular, FIGS. 27 to 29 show embodiments in which the video display apparatus 100 provides different advertisement content to each user based on the PDI questionnaire, to which the user's answer is applied.

Assume that the PDI questionnaire used in FIG. 27 is the questionnaire according to the embodiment of FIG. 16 and a father logs in to the video display apparatus 100. Referring to FIG. 27, the PDI data storage unit 156 of the video display apparatus 100 stores the PDI questionnaire including the PDI questionnaire result 713-1. The PDI questionnaire result 713-1 shows that the basketball team “LA” and the basketball player “cobe” are selected in the items included in the PDI questionnaire.

If the users who logs in to the video display apparatus 100 is a father, the video display apparatus 100 may search for the PDI questionnaire corresponding to the father and display advertisement content in which the player “cobe” of the basketball team “LA” appears among the plurality of pieces of advertisement content based on the PDI questionnaire result 713-1 included in the searched PDI questionnaire. More specifically, the filtering engine 170 shown in FIG. 11 may filter the advertisement content which is not related to the player “cobe” of the basketball team “LA” among the plurality of pieces of advertisement content according to the acquired filtering criterion based on the PDI questionnaire. The PDI engine 160 may display only the advertisement content related to the player “cobe” of the basketball team “LA”.

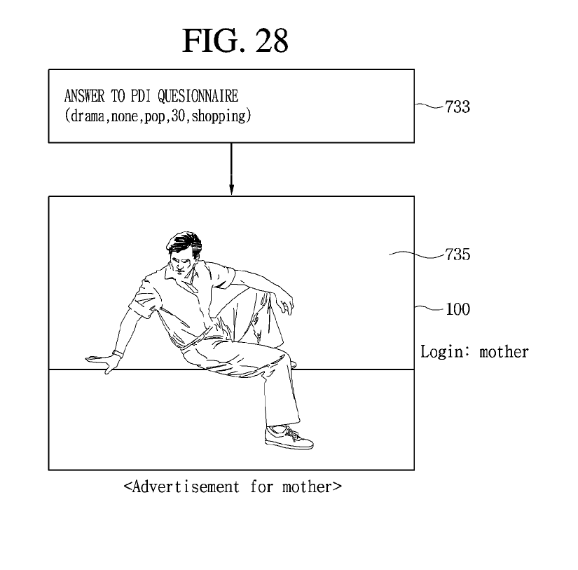

Assume that the PDI questionnaire used in FIG. 28 is the questionnaire according to the embodiment of FIG. 15 and a mother logs in to the video display apparatus 100. Referring to FIG. 28, the PDI data storage unit 156 of the video display apparatus 100 stores the PDI questionnaire including the PDI questionnaire result 733. The PDI questionnaire result 733 shows that drama, pop, thirties and shopping are selected in the items included in the PDI questionnaire.

If the user who logs in to the video display apparatus 100 is a mother, the video display apparatus 100 may search for the PDI questionnaire corresponding to the mother and display the advertisement content 735 related to shopping among the plurality of pieces of advertisement content based on the PDI questionnaire result 733 included in the searched PDI questionnaire.

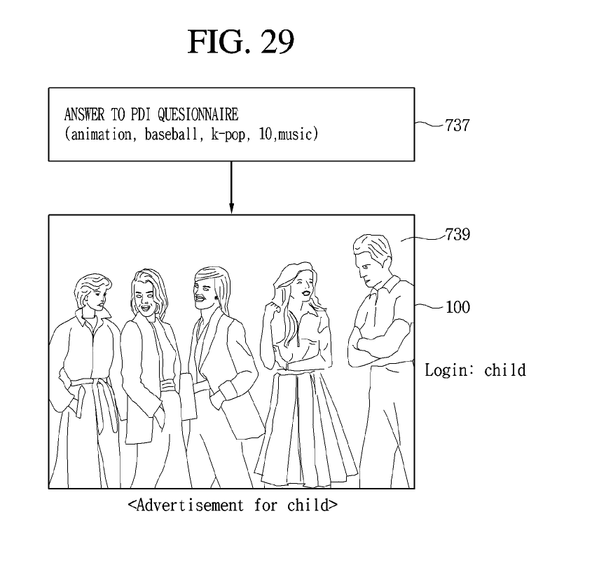

Assume that the PDI questionnaire used in FIG. 29 is the questionnaire according to the embodiment of FIG. 15 and a child logs in to the video display apparatus 100. Referring to FIG. 29, the PDI data storage unit 156 of the video display apparatus 100 stores the PDI questionnaire including the PDI questionnaire result 737. The PDI questionnaire result 737 shows that animation, baseball, K-pop, teens and music are selected in the items included in the PDI questionnaire.

If the user who logs in to the video display apparatus is a child, the video display apparatus 100 may search for the PDI questionnaire corresponding to the child and display the advertisement content 739 in which a k-pop singer appears among the plurality of pieces of advertisement content based on the PDI questionnaire result 737 included in the searched PDI questionnaire.

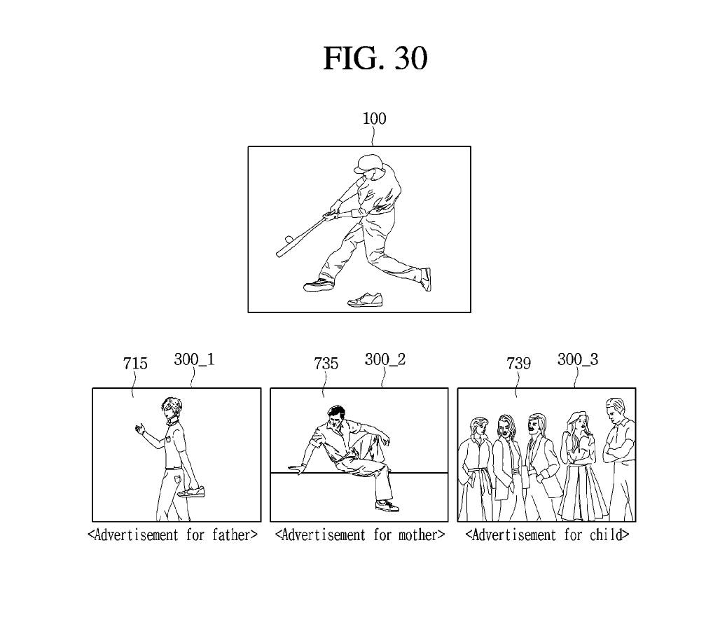

Next, a description will be given with reference to FIG. 30.

FIG. 30 is a diagram showing an example of providing different advertisement content to the companion device of each user according to another embodiment of the present invention.

In FIG. 30, assume that a user group (family group) logs in to the video display apparatus 100. Referring to FIG. 30, each companion device 300 may receive different advertisement content from the content provision server 10 or the video display apparatus 100 based on the PDI questionnaire. The video display apparatus 100 or the content provision server 10 may provide different advertisements to each companion device 300, thereby obtaining positive advertisement effects.

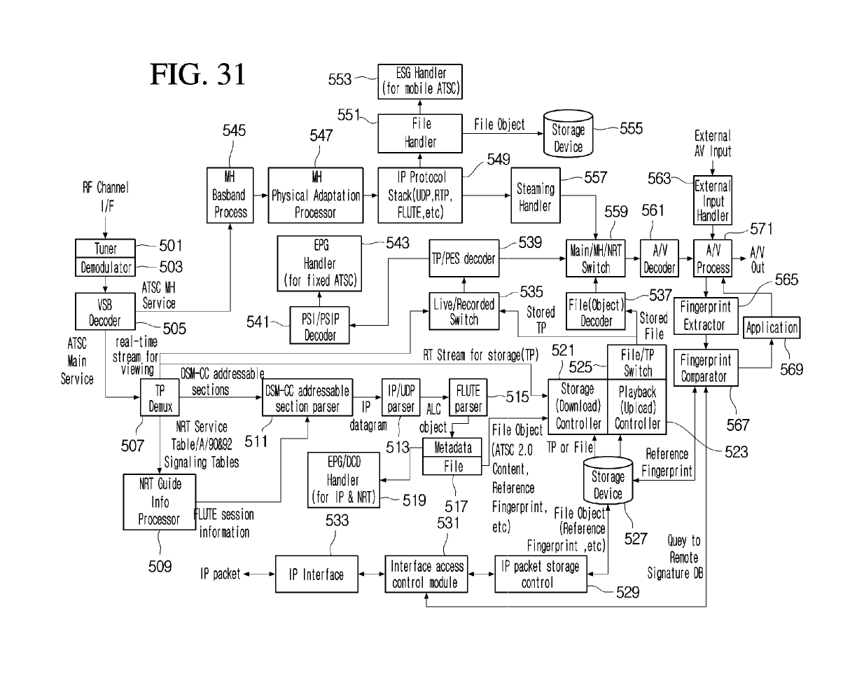

FIG. 31 is a block diagram showing the structure of a fingerprint based video display apparatus according to another embodiment of the present invention.

In FIG. 31, a tuner 501 extracts a symbol from an 8-VSB RF signal transmitted through an air channel.

An 8-VSB demodulator 503 demodulates the 8-VSB symbol extracted by the tuner 501 to restore significant digital data.

A VSB decoder 505 decodes the digital data restored by the 8-VSB demodulator 503 to restore an ATSC main service and an ATSC M/H service.

A MPEG-2 TP demuxer 507 filters a transport packet to be processed by the video display apparatus 100 from between a MPEG-2 transport packet transmitted through the 8-VSB signal or a MPEG-2 transport packet stored in a PVR storage and delivers the filtered transport packet to an appropriate processing module.

A PES decoder 539 buffers and restores a packetized elementary stream transmitted through a MPEG-2 transport stream.

A PSI/PSIP decoder 541 buffers and parses PSI/PSIP section data transmitted through the MPEG-2 transport stream. The analyzed PSI/PSIP data is collected by a service manager (not shown) and is stored in a DB in the form of a service map and guide data.

A DSMCC section buffer/handler 511 buffers and processes DSMCC section data for transmission of a file transmitted through the MPEG-2 TP and IP Datagram encapsulation.

An IP/UDP datagram buffer/header parser 513 buffers and restores IP datagram encapsulated through a DSMCC addressable section and transmitted through the MPEG-2 TP to analyze the header of each datagram. In addition, the IP/UDP datagram buffer/header parser 513 buffers and restores UDP datagrams transmitted through IP Datagrams and parses and processes the restored UDP header.

A stream component handler 557 may include an ES Buffer/Handler, a PCR handler, an STC module, a descrambler, a CA stream buffer/handler and a service signaling section buffer/handler.

The ES buffer/handler buffers and restores an elementary stream such as video or audio data transmitted in the form of a PES and delivers the elementary stream to an appropriate A/V decoder.

The PCR handler processes PCR (Program Clock Reference) data used for time synchronization of the audio and video streams.

The STC module corrects the clock values of the A/V decoders using a reference clock delivered through the PCR handler to perform time synchronization.

If scrambling is applied to the payload of the received IP datagram, a descrambler restores the data of the payload using an encryption key received from the CA stream handler.

The CA stream buffer/handler buffers and processes data such as a descrambling key value such as EMM or ECM transmitted for a conditional access function transmitted through the MPEG-2 TS or IP stream. The output of the CA stream buffer/handler is delivered to the descrambler and the descrambler descrambles the MPEG-2 TP or IP datagram for transmitting the A/V data and file Data.

The service signaling section buffer/handler buffers, restores and parses NRT service signaling channel section data transmitted in the form of the IP datagram. A service manager (not shown) collects and stores the analyzed NRT service signaling channel section data in a DB in the form of the service map and the guide data.

An A/V decoder 561 decodes and presents compressed audio/video data received through the ES handler to the user.

An MPEG-2 service demuxer (not shown)) may include a MPEG-2 TP buffer/parser, a descrambler and a PVR storage module.

An MPEG-2 TP buffer/parser (not shown) buffers and restores the MPEG-2 transport packet transmitted through the 8-VSB signal and detects and processes a transport packet header.

The descrambler restores the data of the payload using the encryption key received from the CA stream hander, with respect to the scrambled packet payload of the MPEG-2 TP.

The PVR Storage module stores the received MPEG-2 TP using the 8-VSB signal according to user request and outputs the MPEG-2 TP according to user request. The PVR storage module may be controlled by the PVR manager (not shown).

The file handler 551 may include an ALC/LCT buffer/parser, an FDT handler, an XML parser, a file reconstruction buffer, a decompressor, a file decoder, and a file storage.

The ALC/LCT buffer/parser buffers and restores ALC/LCT data transmitted through a UDP/IP Stream and parses the header of the ALC/LCT and a header extension. The ALC/LCT buffer/parser may be controlled by the NRT service manager (not shown).

The FDT handler parses and processes a file description table of a FLUTE protocol transmitted through an ALC/LCT session. The FDT handler may be controlled by the NRT service manager (not shown).

The XML parser parses an XML document transmitted through the ALC/LCT session and delivers the parsed data to an appropriate module such as an FDT handler or an SG handler.

The file reconstruction buffer restores a file transmitted through the ALC/LCT or FLUTE session.

The decompressor performs a decompression process if the file transmitted through the ALC/LCT or FLUTE session has been compressed.

The file decoder decodes the file restored by the file reconstruction buffer, the file decompressed by the decompressor or the file extracted from the file storage.

The file storage stores or extracts the restored file as necessary.

The M/W engine (not shown) processes data such as a file, not an A/V stream transmitted through the DSMCC section, IP datagrams, etc. The M/W engine delivers the processed data to a presentation manager module.

The SG handler (not shown) performs a process of collecting and parsing service guide data transmitted in the form of an XML document and delivering the service guide data to the EPG manager.

The service manager (not shown) collects and parses PSI/PSIP data transmitted through the MPEG-2 transport stream and service signaling section data transmitted through the IP stream and produces a service map. The service manager (not shown) stores the produced service map in a service map & guide database and the user controls access to a desired service. The service manager is controlled by an operation controller (not shown) and controls the tuner 501, the MPEG-2 TP demuxer 507, and the IP datagram buffer/handler 513.

An NRT service manager (not shown) performs overall management of an NRT service transmitted in the form of an object/file through the FLUTE session on the IP layer. The NRT service manager (not shown) may control the FDT handler, the file storage, etc.

An application manager (not shown) performs overall management of processing of application data transmitted in the form of an object, file, etc.

A UI manager (not shown) delivers user input to the operation controller through a user interface and starts operation of a process of a service requested by a user.

The operation controller (not shown) processes a user command received through the UI manager and enables the manager of a necessary module to perform a corresponding action.

A fingerprint extractor 565 extracts fingerprint feature information from the audio/video stream.

A fingerprint comparator 567 compares the feature information extracted by the fingerprint extractor with a reference fingerprint and finds matching content. The fingerprint comparator 567 may use a locally stored reference fingerprint DB or receive a result of inquiring a fingerprint inquiry server over the Internet. As the compared result, the matching data may be delivered to and used in an application.

The application 569 is a module for managing an ACR function or an application module for providing an enhanced service based on ACR and identifies broadcast content which is being viewed and provides an enhanced service associated therewith.

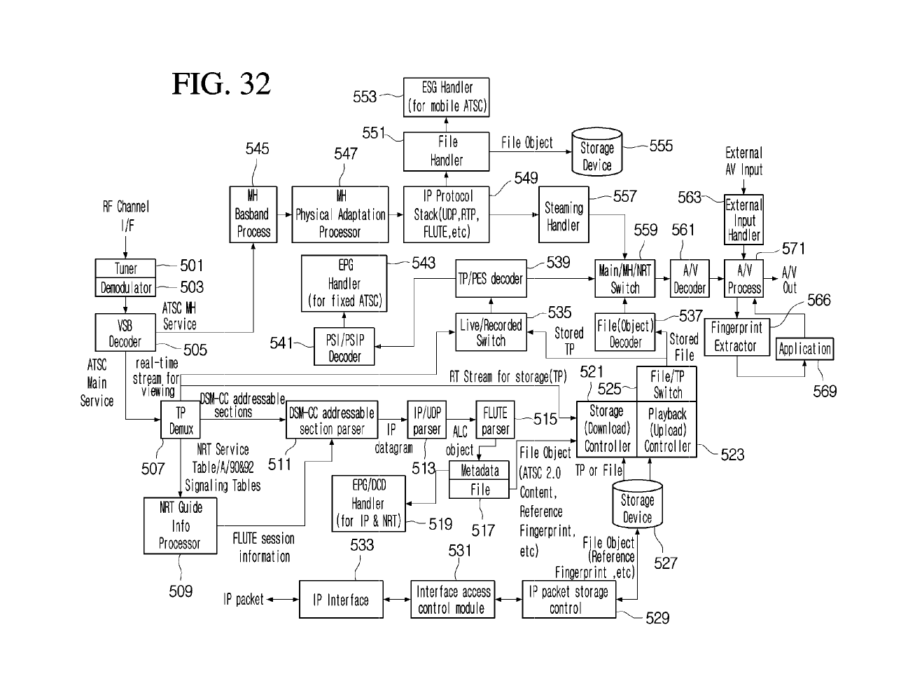

FIG. 32 is a block diagram showing the structure of a watermark based video display apparatus according to another embodiment of the present invention.

The watermark based video display apparatus shown in FIG. 32 is similar to the fingerprint based video display apparatus shown in FIG. 31 except that the fingerprint extractor 565 and the fingerprint comparator 567 of the fingerprint based video display apparatus are not included and instead a watermark extractor 566 is further included.

The watermark extractor 566 extracts data inserted in the form of a watermark from the audio/video stream. The extracted data may be delivered to and used in the application.

According to one embodiment of the present invention, the above-described method may be implemented as code that can be written to a processor-readable recording medium and can thus be read by a processor. Examples of the processor-readable recording medium include a ROM, a RAM, a CD-ROM, a magnetic tape, a floppy disk, optical data storage, and a carrier wave (e.g., data transmission over the Internet).

The above-described video display apparatus is not limited to the configurations and the methods of the above-described embodiments and some or all of the embodiments may be combined such that the above-described embodiments may be variously modified.

1. A method of operating a video display apparatus, the method comprising:
recognizing content using an automatic content recognition scheme;
displaying a questionnaire for a personalized service if the number of times of using the recognized content is equal to or greater than a threshold;
receiving an answer of a user to the displayed questionnaire; and
providing the personalized service based on the questionnaire, to which the received answer of the user is applied.

2. The method according to claim 1, wherein the providing of the personalized service includes:
acquiring a plurality of pieces of advertisement content; and
displaying an advertisement content related to the questionnaire, to which the answer of the user is applied, among the plurality of pieces of advertisement content.

3. The method according to claim 2,
wherein the plurality of pieces of advertisement content has the same display time, and
wherein the displaying of the advertisement content includes:
filtering out advertisement content unrelated to the questionnaire, to which the answer of the user is applied, among the plurality of pieces of advertisement content; and
displaying the advertisement content according to the filtered result.

4. The method according to claim 1, wherein the questionnaire includes:
a plurality of question items related to the recognized content; and
a plurality of options for giving answers to the plurality of question items.

5. The method according to claim 1, further comprising:
receiving identification information of the user; and
identifying the user based on the received identification information of the user.

6. The method according to claim 1, wherein the number of times of using the content includes at least one of the number of times of viewing a specific channel for a predetermined time, the number of times of viewing a program of a specific genre for a predetermined time and the number of times of executing a specific application.

7. The method according to claim 1, further comprising transmitting the questionnaire for the personalized service to a companion device paired with the video display apparatus.

8. The method according to claim 1, further comprising:
storing the questionnaire for the personalized service; and
disabling display of the questionnaire if the questionnaire is stored and the number of times of reusing the recognized content is equal to or greater than the threshold.

9. A video display apparatus comprising:
a display unit; and
a controller configured to:
recognize content using an automatic content recognition scheme, to control the display unit to display a questionnaire for a personalized service if the number of times of using the recognized content is equal to or greater than a threshold,
receive an answer of a user to the displayed questionnaire, and
provide the personalized service based on the questionnaire, to which the received answer of the user is applied.

10. The video display apparatus according to claim 9, wherein the controller acquires a plurality of pieces of advertisement content and displays an advertisement content related to the questionnaire, to which the answer of the user is applied, among the plurality of pieces of advertisement content.

11. The video display apparatus according to claim 10,
wherein the plurality of pieces of advertisement content has the same display time, and
wherein the controller filters out advertisement content unrelated to the questionnaire, to which the answer of the user is applied, among the plurality of pieces of advertisement content and displays the advertisement content according to the filtered result.

12. The video display apparatus according to claim 9, further comprising a user management engine configured to receive identification information of the user and to identify the user based on the received identification information of the user.

13. The video display apparatus according to claim 9, wherein the number of times of using the content includes at least one of the number of times of viewing a specific channel for a predetermined time, the number of times of viewing a program of a specific genre for a predetermined time and the number of times of executing a specific application.

14. The video display apparatus according to claim 1, further comprising a companion module configured to transmit the questionnaire for the personalized service to a companion device paired with the video display apparatus.

15. The video display apparatus according to claim 9, further comprising a memory configured to store the questionnaire for the personalized service,
wherein the controller controls the display unit not to display the questionnaire if the questionnaire is stored and the number of times of reusing the recognized content is equal to or greater than the threshold.
